(19) United States
(12) Patent Application Publication
(10) Pub. No.: US 2014/0231502 A1
(43) Pub. Date: Aug. 21, 2014

(54) METHODS AND SYSTEMS FOR PROVIDING SUBJECT-SPECIFIC SURVEY CONTENT TO A USER WITH SCANABLE CODES

(71) Applicants: Peter Joseph Marsico, Chapel Hill, NC (US); Sir Robert Burbridge, Durham, NC (US)

(72) Inventors: Peter Joseph Marsico, Chapel Hill, NC (US); Sir Robert Burbridge, Durham, NC (US)

(21) Appl. No.: 14/185,488

(22) Filed: Feb. 20, 2014

Related U.S. Application Data
(60) Provisional application No. 61/850,648, filed on Feb. 20, 2013.
(60) Provisional application No. 61/851,696, filed on Mar. 12, 2013.

(51) Int. Cl. G06F 17/30

(52) U.S. Cl. CPC G06F 17/30879; G06F 17/30876
USPC 235/375

(57) ABSTRACT

Disclosed are methods, systems and computer program products for surveying a user using a scan-code tag, such as a quick response code. In one embodiment, a mobile communication device such as a smartphone, tablet computer or other mobile computer is adapted to include a survey client module for scanning and communicating scan code information, where the information can be used to identify a surveying entity and a subject-specific survey area or other auxiliary information. The survey client module communicates the scanned survey scan code information to an associated server. In response to receiving the information, the application server is adapted to select survey content related to the specified survey subject area and to communicate this selected subject-specific survey content to the user. The user responds to the provided subject-specific survey content and provides associated survey response information to the application server.

### PRIORITY CLAIM

This application claims the benefit of U.S. Provisional Patent Application Ser. No. 61/850,648, filed Feb. 20, 2013 and U.S. Provisional Patent Application Ser. No. 61/851,696, filed Mar. 12, 2013; the disclosures of which are incorporated herein by reference in their entireties.

### TECHNICAL FIELD

The subject matter described herein relates to methods and systems for collecting feedback from or surveying a user using scanable codes.

### BACKGROUND

Information collection systems that are typically deployed to gather information from a consumer of goods and services are often intrusive and time consuming from the perspective of the consumer. While such information collection systems are capable of gathering detailed feedback information from a consumer, these systems do not give the user an easy way to collect and utilize survey control and metadata information, such as information that specifies a survey subject area, survey deployment location, associated employee information, etc., of the survey content that is to be presented. Additionally, the time and effort required to simply provide the requested feedback information is such that many consumers chose not to participate.

In light of these problems, what is needed is a system and method for efficiently and conveniently collecting feedback and associated survey control and metadata information from a user.

### SUMMARY

According to one aspect, the subject matter described herein includes systems and methods for surveying a user using a scanable information element, such as a radio frequency identification (RFID) encoded tag, a near field communication (NFC) encoded tag, or an encoded graphic image, such as a bar code or a quick response (QR) code tag. In one embodiment, a mobile communication device such as a smartphone, tablet computer, computer integrated eyeglasses or other mobile computer is adapted to include a survey client module for scanning and communicating QR code information. A survey client module may, for example, include a multi-purpose or stand-alone QR code scanner application that is downloaded and installed on a smartphone, or a native scan code-based survey application that is downloaded and installed on a smartphone. QR code scanning is accomplished by a camera module that is associated with the smartphone or other mobile computing device. The survey client module communicates the scanned QR code information to an associated server application for collecting, processing and reporting survey data. In one embodiment, information contained in the scanned QR code is decoded by the survey client module and communicated to the associated server application. The information encoded in the QR code includes information that is sufficient to identify a surveying entity (e.g., a local retailer or merchant) and a survey subject area (e.g., wait staff service, food quality, cleanliness, etc.). For example, a uniform resource locator (URL) value may be used to identify the surveying entity and one or more parameter values included in the URL value may be used to identify a subject area. For example, in one embodiment, a subject area identifier may be used to identify a particular survey topic (e.g., “food quality”, “service quality”, etc.). In another exemplary embodiment, a subject area identifier may be used to identify a particular survey question. In one exemplary embodiment, the server application is adapted to receive the scan information sent by the survey client module and to return to the survey client module a survey question and survey content (e.g., selectable response options for the question or questions) related to the specified survey subject area. The survey question and associated selectable response option information is displayed to a user of the survey client module. The user (e.g., mobile smartphone user) responds to the displayed survey question by selecting one or more of the response options. As a result, information which can be used to identify the selected response option or options is communicated to the server application, where it is stored, analyzed and used to generate user feedback reports. An example of one implementation of such an embodiment might include a QR code that includes the information described above, where the QR code is displayed with a text label “Food Quality,” which visually identifies the subject area to the user. When the user scans the associated QR code, the server application receives the information obtained from the scan, as generally described above, and returns to the user's mobile device one or more questions that are displayed on the user's mobile device screen. Exemplary questions returned by the server application might include “How did the food taste?”, “Was the food presented well?”, etc. Also returned by the server application is a set of selectable response options for each question. For example, “Food tasted bad” and “Food tasted great” may be the response options returned with respect to the first question. Using the touch screen on the user's mobile device, the user can select one of the returned questions. Once a question is selected, the associated response options are displayed to the user. The user can then touch or tap the desired response option. Once a response option is tapped or touched, response option identification information, which can be used by the server application to identify the selected response option, is communicated to the server application where it is stored, used in subsequent analysis, and reported.

In another exemplary embodiment, the server application is adapted to receive the scan information sent by the survey client module and to return to the survey client module one or more response options for the associated subject-area or question. For example, the response options returned by the server application might include “Food tasted bad” and “Food Tasted Great.” The response options are displayed to the user in a manner similar to that described above for the previous embodiment. The user can then touch or tap the desired response option. Once a response option is tapped or touched, response option identification information, which can be used by the server application to identify the selected response option, is communicated to the server application where it is stored, used in subsequent analysis, and reported.

In another embodiment, an image (e.g., JPEG, bitmap, etc.) of the scanned QR code icon is provided by the survey client module to the associated server application. In this case, the server application is adapted to decode the information encoded in the QR code, and to return to the survey client module survey questions and/or survey content (e.g., response options). The survey questions and/or survey content is displayed to a user of the survey client module. The user (e.g., mobile smartphone user) responds to the displayed survey questions and/or survey content and the user's survey response option selection information is communicated to the server application. The server application is adapted to store, analyze and generate reports based on the provided survey response option selection information.

According to another aspect, the subject matter described herein includes systems and methods for collecting metadata, such as deployment location, customer service representative identification information, intra-store location and other types of information that is related to a survey, but that is not a survey response per say. Such survey metadata associated with embodiments of the scan-based survey platform is referred to herein as auxiliary survey information and may be encoded in a survey scan code.

According to yet another aspect, the subject matter described herein includes systems and methods for distributing and redeeming a survey participation reward voucher to a survey respondent in response to receiving subject area-specific survey response information from the survey respondent. In one embodiment, survey participation reward voucher content information (e.g., text which describes the reward voucher, a graphic image associated with the reward voucher, etc.) is communicated from the server application to the survey client module. At least a portion of the survey participation reward voucher content information is displayed to the user associated with the mobile communication device. The user may select the survey participation reward voucher for redemption. According to one exemplary embodiment, in response to selecting the survey participation reward voucher for redemption, the survey client module prompts the user to scan a scanable tag (e.g., QR code) associated with a surveying entity. The information encoded in the QR code includes information that is sufficient to identify the surveying entity. At least a portion of the scanned QR code information, as well as information which is sufficient to identify the selected survey participation reward voucher is communicated by the survey client module to the server application. In response to receiving this information, the server application records that the survey participation reward voucher has been redeemed and communicates a redemption or authorization code to the survey client software module. The redemption or authorization code may be provided to the entity (e.g., business, retailer, etc.) with which the survey participation reward voucher is being redeemed so as to provide evidence that the survey participation reward voucher is considered to be redeemed by the server application. Other reward voucher redemption procedures and techniques may be implemented within the scope of the subject matter described herein.

The subject matter described herein for facilitating scan code-based user surveying may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a non-transitory computer readable medium having stored thereon computer executable instructions that when executed by the processor of a computer perform steps. Exemplary computer readable media suitable for implementing the subject matter described herein include disk memory devices, programmable logic devices, and application specific integrated circuits. In addition, a computer readable medium that implements the subject matter described herein may be located on a single device or computing platform distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a functional block diagram which illustrates a mobile communication device, such as a smartphone, that includes a camera and exemplary survey client module;

FIG. 2 is a functional block diagram which illustrates an application server that includes an exemplary server application module;

FIG. 3 is a diagram that illustrates exemplary user, surveying entity and survey participation reward provisioning data;

FIG. 4 is a diagram that illustrates exemplary subject-specific survey information, primary and follow-up survey content data;

FIG. 5 is a diagram that illustrates exemplary subject-specific survey response data;

FIG. 6 is a diagram that illustrates exemplary survey participation reward redemption data;

FIG. 7 is an information flow diagram that illustrates an exemplary scanable subject-specific survey transaction and an associated follow-up survey transaction;

FIG. 8 is an information flow diagram that illustrates an exemplary distribution of a survey participation reward and associated reward redemption processing;

FIG. 9 is an information flow diagram that illustrates exemplary provisioning and data reporting transactions;

FIG. 10 is a diagram that illustrates an exemplary use case scenario of scanable survey codes which include encoded auxiliary location information;

FIGS. 11A and 11B are diagrams that illustrate exemplary survey content and auxiliary survey information data associated with one exemplary embodiment which involves the use of auxiliary survey location identification information;

FIG. 12 is a diagram that illustrates an exemplary use case scenario of scanable survey codes which include encoded auxiliary employee identification information;

FIG. 13 is a diagram that illustrates an exemplary use case scenario of scanable survey codes which include encoded auxiliary user identification information;

FIG. 14 is a diagram that illustrates exemplary survey content and auxiliary survey information data associated with exemplary embodiments which involves the use of auxiliary survey employee and user identification information;

FIG. 15 is a diagram that illustrates an exemplary use case scenario of scanable survey codes which include encoded auxiliary goods and service identification information; and

FIG. 16 is a diagram that illustrates exemplary survey content and auxiliary survey information data associated with exemplary embodiments which involves the use of auxiliary survey goods and service identification information.

### DETAILED DESCRIPTION

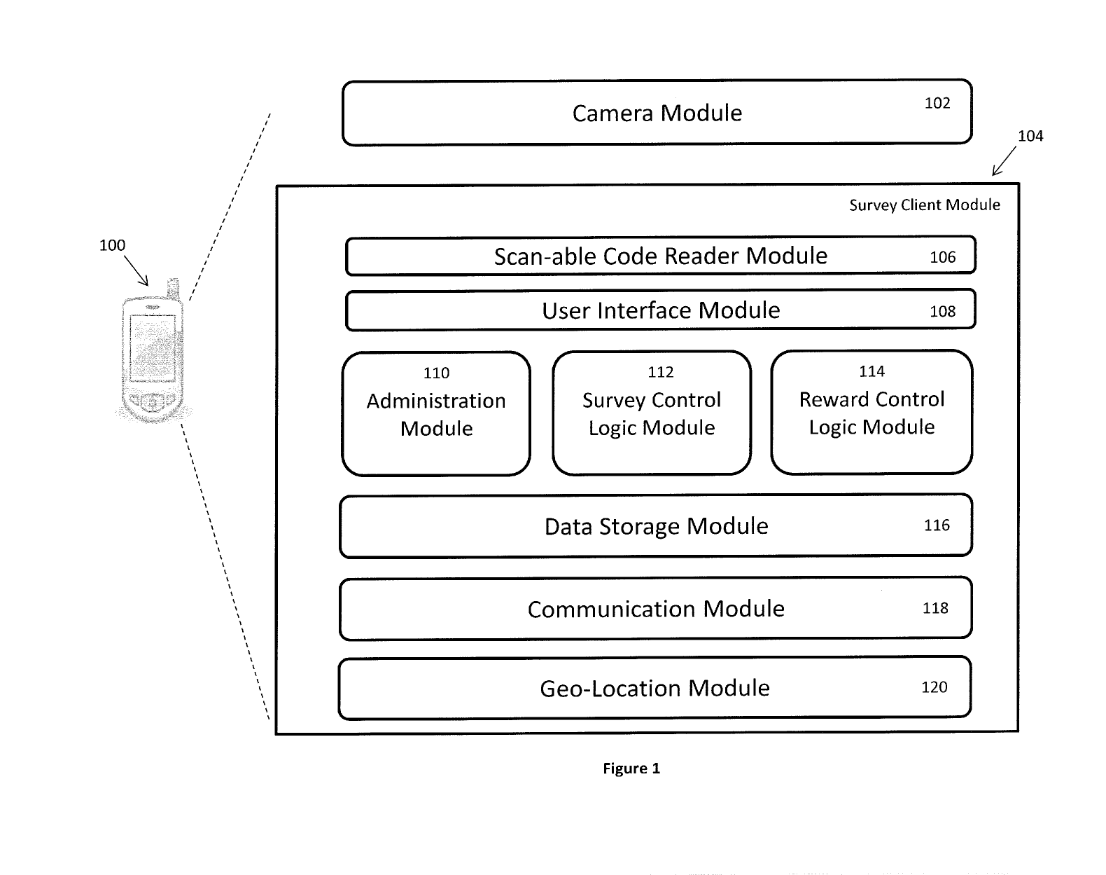

Disclosed are systems and methods for collecting survey information from a user with regard to a good or service provided by a surveying entity (e.g., retailer, merchant, corporation, etc.), and for processing and reporting the collected survey information to the surveying entity. In one embodiment, subject-specific survey information is collected from a user via the scanning of a scanable survey code and utilized by a scan-based survey system. Exemplary subject-specific survey areas include, but are not limited to, staff service, food quality, store ambience, cleanliness, etc. Exemplary surveying entities include, but are not limited to, commercial enterprises, such as wholesale or retail businesses, medical and dental practices, restaurants, etc. In a preferred embodiment, the subject matter described herein includes a survey client module, which may be implemented in hardware, software, firmware or a combination thereof and which resides on a mobile communication device, such as a smartphone, tablet computer, netbook computer, computer integrated eyeglasses or other mobile computing device. The survey client module may include an executable computer program or application (e.g., C++, Java, etc.) that is adapted to be downloaded onto the mobile communication device, installed and executed. The survey client module may also include a web browser that is adapted to access and execute web-based, web-app software that provides some or all of the necessary survey client module functionality. Shown in FIG. 1 is a block diagram that illustrates an exemplary architecture of a smartphone-based survey client module. Smartphone 100 includes a camera module 102 that is adapted to capture and store an image in a digital format. Smartphone 100 also includes a survey client module 104. Survey client module 104 is comprised of scan code reader module 106, a user interface module 108, an administration module 110, a survey control logic module 112, a survey participation reward control logic module 114, a data storage module 116, and a communication module 118.

In one embodiment, scan code reader module 106 is adapted to receive digital image information associated with a photographed scan code icon, such as a quick response (QR) code, bar code, or other graphic encoding format. Reader module 106 analyzes and decodes or extracts digital information encoded within the scan code icon image. The extracted information may comprise information that is representative, for example, of an alphanumeric text string, a numeric code. The extracted information may identify a surveying entity (e.g., business entity) and a surveying entity location (e.g., a store or retail location associated with a business entity). The extracted information also identifies a specific survey subject area (e.g., service quality, food quality, location ambiance, etc.). It will be appreciated that a survey subject area may be presented to a user in the form of a question (e.g., “How was the food quality?” etc.). The decoded scan code information is provided to an associated server application module via communication module 118. In an alternate embodiment, scan code reader module 106 is adapted to receive digital image information from camera module 102 and to communicate the digital image information (e.g., JPEG) to an associated server application module via communication module 118 where decoding processing is performed. In one embodiment, information that identifies or can be used to identify a survey client module user (e.g., user name, user ID, session ID, etc.) is also provided to the server application module.

User interface module 108 is adapted to present the mobile device user with a graphical user interface for enabling the user to generally control and operate the functionality of the survey client module. User interface module 108 is adapted to present a menu structure to the user and enable the user to navigate this menu structure. The menu structure provides a user with access to administrative functions, such as account settings (e.g., username, password, service preferences, personal information, etc.), account log-in. Such administrative functions are controlled within survey client module 104 via administration module 110. The menu structure may also provide the user with the ability to control the associated smartphone camera. In some embodiments, the ability to access and operate the smartphone camera in the manner required to effectively photograph or scan a scan code icon, such as a QR code, is provided via survey control logic module 112. In one exemplary embodiment, a survey client module may include a native application that is adapted to execute on the mobile device, and in such a case that native application may include QR scanning/decoding capability or alternatively the survey client module may simply invoke the services of a third-party QR scanner/decoder that is installed in the mobile device. In another exemplary embodiment, a third-party QR scanner/decoder may be invoked by the mobile device user to scan and decode a suitably provisioned QR, where decoding of the QR code causes a web browser instance to be launched and directed to a URL associated with the application server. In this case, information that identifies the surveying entity and subject-specific survey may be passed to the application server via the URL/URL parameters. For example, in one embodiment, information that identifies the surveying entity and/or the subject-specific area may be explicitly or implicitly communicated to the application server via the URL itself (e.g., the host name and/or path and/or query string components of the URL can be used by the application server to explicitly or implicitly identify the surveying entity). In an alternate embodiment, for example, all communications between the user's mobile device and the application server may be addressed to a URL which points to a scan-based service provider (e.g., www.flashbacksurvey.com), and the information that identifies the surveying entity and/or the subject-specific area may be communicated to the scan-based service provider's application server via the path and/or query string parameter portions of the URL. The menu structure also provides the user with the ability to access and redeem survey participation rewards. Survey participation reward access and redemption functionality is provided by survey participation reward control logic module 114.

Data storage module 116 is adapted to provide both long term storage of data associated with the survey client module, as well as short term, cache-type storage of surveying entity related data. Exemplary uses of the data storage are discussed in more detail in the disclosure that follows.

Communications module 118 is adapted to facilitate the communication of information between survey client module 104 and an associated server application module. For example, communication module 118 may receive information from survey control logic module 112 that is to be communicated to an associated server application module. Communication module 118 may package the information according to a pre-defined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), Long Term Evolution (LTE), WiMax, WiFi, etc. For example, in one embodiment, when a user scans a survey response QR code, communication module 118 is adapted to communicate to an associated server application module information that was encoded in the scanned survey response QR code as well as information that can be used to identify the user. Information that can be used to identify the user may include a user identifier (e.g., username, email address, mobile IP address, communication session ID, etc.). It will be appreciated that the communication of such user identifying information to the server module may be triggered upon scanning of the QR code or may be triggered upon startup of software associated with survey client module 104 (e.g., auto-login, manual login, etc.).

In one exemplary embodiment, geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling the server application module to identify and store the location at which a QR code was scanned.

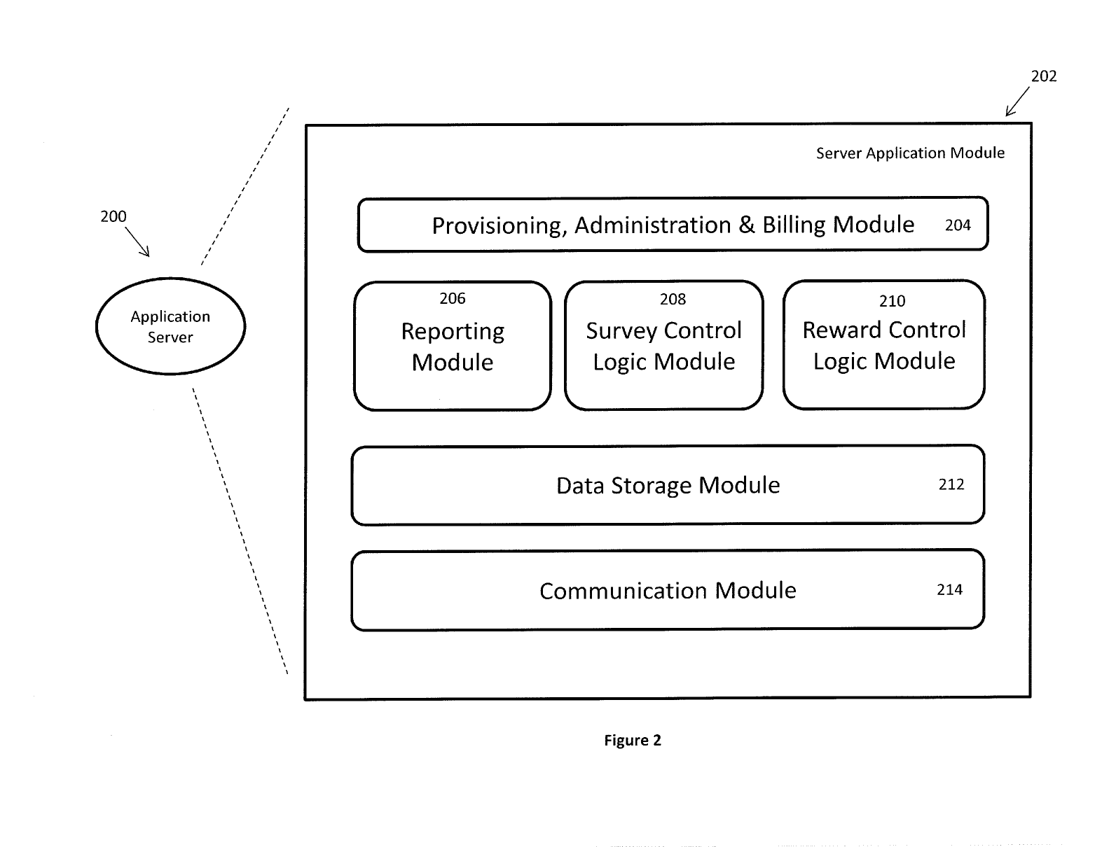

Shown in FIG. 2 is a block diagram that illustrates an exemplary architecture of a server application module 202, which resides and executes on a network or cloud-hosted application server 200. In the embodiment presented in FIG. 2, the server application module is comprised of a provisioning, administration and billing module 204, a reporting module 206, a survey logic control module 208, a survey participation reward control logic module 210, a data storage module 212, and a communication module 214.

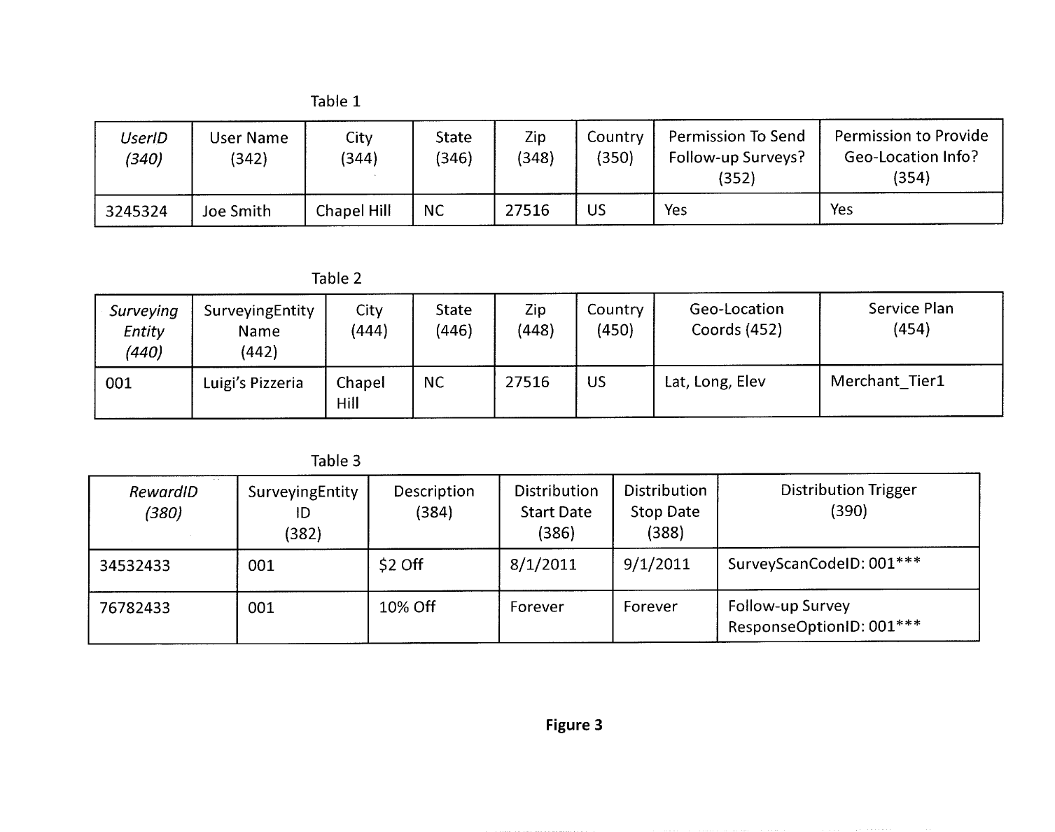

Provisioning, administration and billing module 204 is adapted to provide access for a user, such as a surveying entity, mobile user entity or a system administrator, to provision registration information, subscription configurations/preference information, survey content information, and survey participation reward content information. Exemplary user registration and configuration settings information is presented in Table 1, as shown in FIG. 3. In the context of this disclosure, a user is considered to be the operator or user of a mobile communication device (e.g., smartphone, tablet computer, etc.) that includes a survey client module, and is therefore capable of scanning a QR code (or other encoded, optically scanable icon) and providing survey data to an associated application server. For example, a user may be a consumer of goods and services provided by a merchant, or an employee of a business or corporation.

Table 1 includes UserID information 340, user name information 342, user city 344, user state 346, user zip code 348, user country 350, Follow-up Survey permission information 352, and geo-location data sharing permission information 354. The user information shown in Table 1 is merely exemplary and is not intended to be a comprehensive listing. Exemplary surveying entity registration and configuration settings information is presented in Tables 2 and 3, as shown in FIG. 3. In the context of this disclosure, a surveying entity is considered to be an entity that wishes to survey a user. For example, a surveying entity may be a retailer or merchant of goods and services, or a corporation that wishes to survey its employees. Table 2 includes SurveyingEntityID information 440, SurveyingEntity name information 442, SurveyingEntity city 444, SurveyingEntity state 446, SurveyingEntity zip code 448, SurveyingEntity country 450, SurveyingEntity geo-location data 452, and service plan information 454. The surveying entity information shown in Table 2 is merely exemplary and is not intended to be a comprehensive listing. Table 3 includes survey participation reward identification information 380, surveying entity identification information 382, survey participation reward description information 384, reward distribution start date information 386, reward distribution stop date information 388, and reward distribution trigger criteria information 390.

Returning to FIG. 2, a surveying entity, such as a restaurant owner, may log in to server application module 202 and, via module 204, construct or provision survey content associated with a survey of customer satisfaction with the service at the owner's restaurant. The surveying entity may implicitly or explicitly define a survey subject area or category (e.g., Wait Staff Service) and one or more survey questions associated with the survey subject area or category, such as “Was the wait staff friendly?” Information that identifies the survey subject area or category and the associated question are stored in a data structure or database associated with data storage module 212. One or more response options associated with the survey question are also defined and stored in data storage module 212. Exemplary responses might include, “Yes” and “No”. In one embodiment, each survey response option is categorized according to the disposition of the response option. For example, a response option may be categorized as “positive”, “negative”, or “neutral.” Multiple response disposition categories may be associated with a single response option. As such, survey responses collected from users can be quickly grouped, analyzed and displayed according to disposition category.

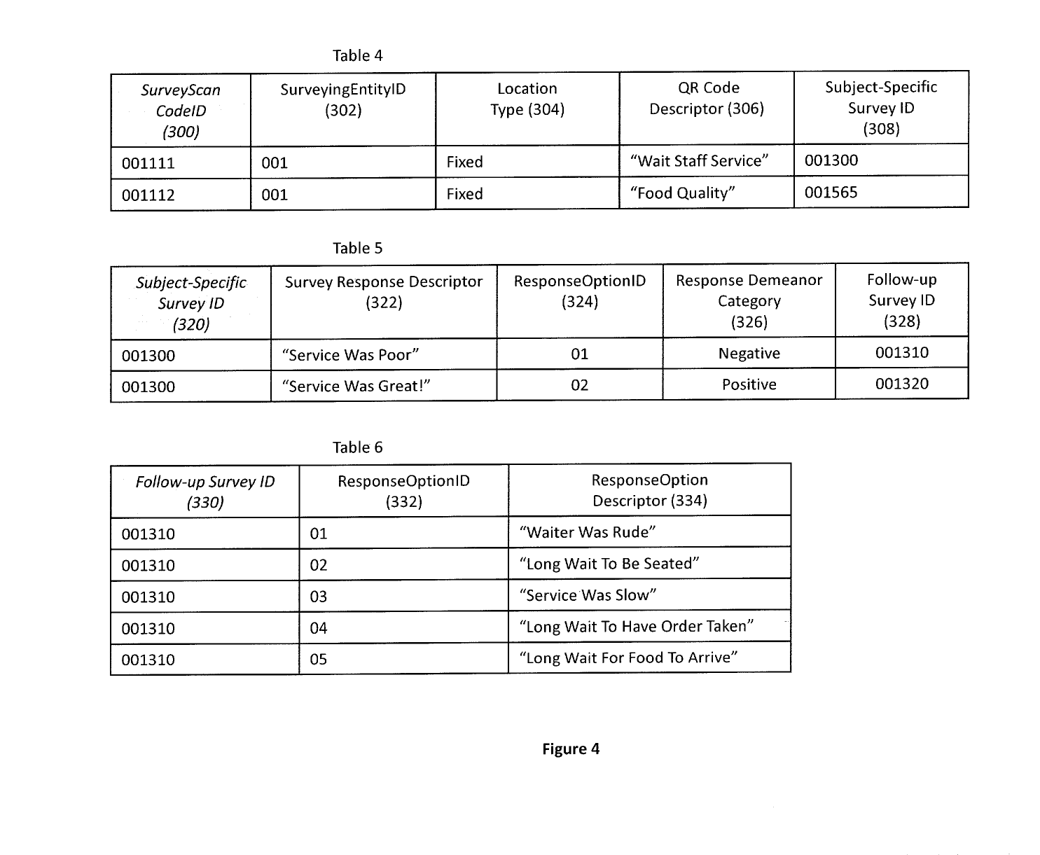

In one embodiment, a code is associated with a predefined survey subject area for a surveying entity. As such, the code is explicitly associated with and uniquely identifies both a surveying entity and a subject-specific survey or survey area. Exemplary subject-specific survey content data is presented in Table 4, shown in FIG. 4. Each exemplary survey content record in Table 4 includes a QR code identifier 300, a SurveyingEntityID 302, a location type indicator 304, QR code descriptor text descriptor information 306, and subject-specific survey identification information 308. It will be appreciated, in the sample data shown in Table 4, that the QR code identifier values chosen incorporate the SurveyingEntityID value in the first three digits (i.e., 001). As such, the QR code assigned to the subject-specific survey area “Wait Staff Service” includes information that is sufficient to explicitly identify both the surveying entity (i.e., “Luigi's Pizzeria”) with which the survey is associated and the subject-specific survey area (i.e., “Wait Staff Service”).

Provisioning, administration and billing module 204 is adapted to generate an encoded scanable graphic icon (e.g., QR code icon) associated with each possible subject-specific survey area, where the information encoded in the scanable graphic icon includes information that can be used to identify the surveying entity and the associated subject-specific survey area of interest.

According to one aspect of the subject matter described herein, in response to the scanning of a scanable graphic code (e.g., QR code) that encodes a surveying entity identifier and a subject-specific survey area identifier, survey content information associated with the surveying entity and specified subject area is sent to the mobile device of the user who scanned the QR code. Shown in FIG. 4 are Tables 5 and 6, which illustrate an exemplary subject-specific survey data structure that may be provisioned for a surveying entity via module 204. Table 5 includes Subject-specific survey ID information 320, survey response descriptor information 322, ResponseOptionID information 324, Response Demeanor Category information 326, and optional Follow-up Survey ID information 328. Table 6 includes Follow-up survey ID information 330, ResponseOptionID information 332, and ResponseOption Descriptor information 334. With regard to Response Demeanor Category information 326, it will be appreciated that by pre-associating a response demeanor category (e.g., this response option should be interpreted as positive feedback, this response option should be interpreted as negative feedback, this response option should be interpreted as neutral feedback, etc.) with each response option, subject-specific survey response feedback from a large population of users may be quickly and easily aggregated for reporting and viewing purposes. For example, a surveying entity can easily log-in to the surveying system and chose to view a real-time report that organizes and presents user feedback in terms of all received “positive” feedback or all received “negative” feedback. The ability to categorize and sort survey feedback response information by demeanor category is a very useful and important feature/aspect of the subject matter described herein.

Continuing with the previous survey example, if a user scans the QR code icon that encodes the value “001111” which is associated with the subject-specific survey area “Wait Staff Service” (see Table 4, record 1), subject-specific survey content is subsequently sent and displayed to the user. In this example, the subject-specific survey content includes the response statements/options “Service Was Poor” and “Service Was Great!” Further associated with the “Service Was Poor” response option are five follow-up survey response options that are presented to the user in the event that user selects the “Service Was Poor” response option. User input with regard to these subject-specific survey and associated follow-up survey solicitations is communicated from the mobile device to the server application where it is validated, stored, analyzed and reported to the surveying entity. It will be appreciated that additional follow-up survey content, associated with some or all of the five follow-up response options, may be provisioned and communicated to a user during the course of a survey transaction/session and as such multiple levels of follow-up survey content “nesting” is contemplated.

Reporting module 206 is adapted to provide access to survey data that has been collected as well as to survey participation reward distribution and redemption information. In one embodiment, reporting module 206 analyzes collected survey data and generates summary reports associated with the survey data. Module 206 may generate and report statistics that are based on collected survey data. Reports generated by module 206 may be viewed, for example, by a surveying entity via a web browser or other software interface. Module 206 may also provide survey, participation reward and redemption data and associated statistics in a downloadable format, such as a spreadsheet or portable document format. In one embodiment, report module 206 may enable a user to access and view user account information, including user settings, user preferences, survey participation rewards earned, survey participation reward redemption information, survey participation reward transfers to other users, etc.

Returning to FIG. 2, according to one aspect, survey control logic module 208 is adapted to receive and process scanned survey code (e.g., QR code) information from one or more survey client modules. Module 208 facilitates selection and distribution of survey content based on the surveying entity and survey subject area specified in the received scan information. In one exemplary embodiment, module 208 is further adapted to facilitate the storage of collected subject-specific survey response information within an associated data storage module. In an alternate embodiment, module 208 is adapted to decode or “read” an image provided by a survey client module. The image may be, for example, a JPEG formatted graphic image of a QR code icon. The decoded information extracted from the QR code icon is then processed and the subsequently received subject-specific survey response option information stored in a manner similar to that described above. Module 208 may also access provisioned follow-up survey rules and communicate follow-up survey content to the user based on the provisioned rules. Module 208 may subsequently receive follow-up survey response information from the user, and log or record this follow-up survey response information and again access the provisioned follow-up survey rules and communicate additional follow-up survey content to the user based on the provisioned rules.

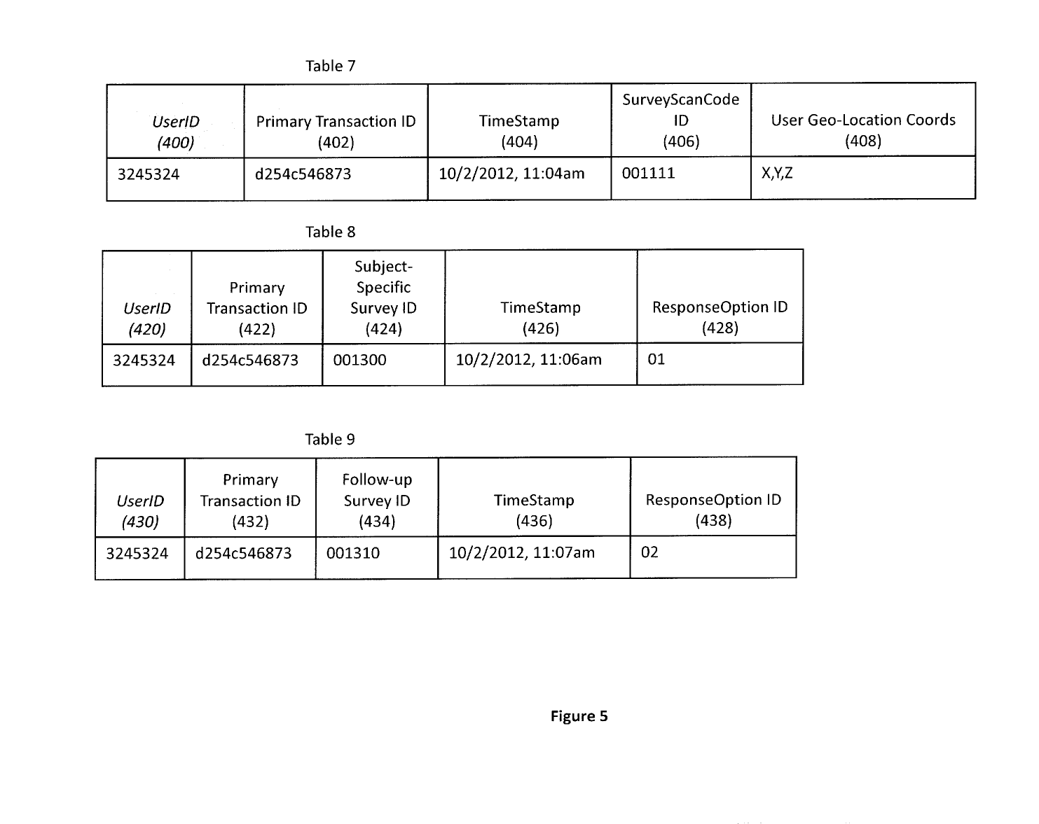

Shown in FIG. 5 are Tables 7, 8 and 9, which illustrates an exemplary survey response transaction data structure that is maintained, for example, in data storage module 212. Table 7 includes UserID information 400, survey response transaction identifier information 402, transaction timestamp information 404, scanned survey response code (e.g., QR code) information 406, and user geo-location coordinate information at the time of the survey response transaction 408. Table 8 includes UserID information 420, survey response transaction identifier information 422, subject-specific survey identification information 424, transaction timestamp information 426, and response option identification information 428. Table 9 includes UserID information 430, survey response transaction identifier information 432, follow-up survey identification information 434, transaction timestamp information 436, and response option identification information 438.

Returning to FIG. 2, reward control logic module 210 is adapted to operate in conjunction with module 208 so as to receive or be informed of scanned subject-specific survey code (e.g., QR code) and/or associated survey response information provided by a user/survey client module. In one embodiment, module 210 is adapted to distribute a survey participation reward, such as a coupon or voucher that may be exchanged for a good or service, to a user based on survey scan code (e.g., QR code) information received from the user or from follow-up survey response information received from the user. To determine which survey participation reward content to distribute, module 210 may access provisioned reward rules data, such as the exemplary survey participation reward data shown in Table 3.

In an alternate embodiment, module 210 is adapted to distribute survey participation reward content to a user based on criteria other than received survey scan code or follow-up survey response information. For example, module 210 may distribute reward content based on the number of survey response events or transactions initiated by a user. In one scenario, a user is sent a survey participation reward by module 210 for every 25^{th} survey response event associated with the user. In another scenario, module 210 may periodically or randomly distribute reward content to a user.

Module 210 is also adapted to receive and process a request by a user/survey client module to redeem a survey participation reward. The user/survey client module requesting to redeem a survey participation reward provides information which identifies the reward to be redeemed and the redemption entity. A redemption entity is defined herein as any entity (e.g., retail merchant, corporation, etc.) that exchanges a survey participation reward for a good or service. Module 210 is adapted validate the redemption request. Validation of a redemption request may include, but is not limited to, confirming that the requesting user has been previously given the reward associated with the redemption request, confirming that the reward associated with the redemption request has not expired, confirming that the redemption entity information provided is valid, confirming that the user is in good standing.

In one embodiment, module 210 may facilitate the sharing, gifting, or transfer of a survey participation reward from one user to another user. In this case, a first user who is the current owner of a survey participation reward, selects the reward and identifies a second user to whom the reward is to be transferred. The first user then communicates information that identifies both the reward and the “transferred to” user to module 210. Module 210 receives, processes and logs the transfer request and updates the appropriate reward data so as to execute the transfer. In one embodiment, reporting module 206 enables a surveying entity or user to view, track and analyze such reward transfers.

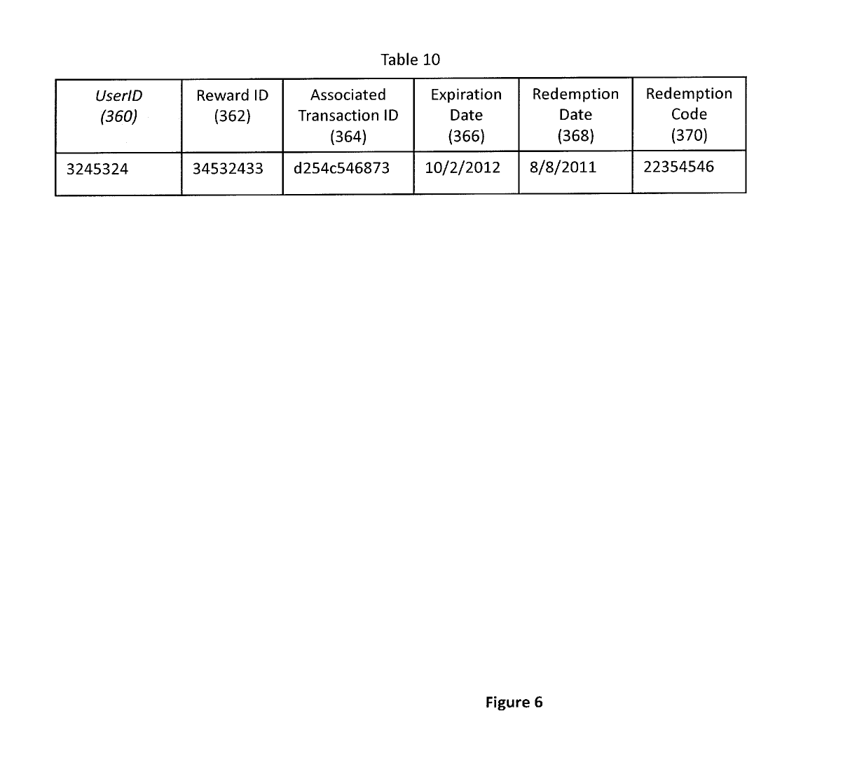

Shown in FIG. 6 is Table 10, which includes exemplary survey participation reward redemption data that is stored in a data storage module. Table 10 includes UserID information 360, survey participation reward identification information 362, survey response transaction identifier information associated with the survey response that triggered issuance of the survey participation reward 364, survey participation reward expiration information 366, survey participation reward redemption timestamp information 368, and information which identifies a redemption entity 370.

Returning to FIG. 2, data storage module 212 is adapted to include or have access to the data structures, databases, and data tables associated with the storage of survey system data described and suggested herein, some of which is illustrated in Tables 1 through 10. In one embodiment, data storage module 212 may include or make use of a commercially available, cloud-hosted database system, such as Oracle. In any event, data storage module 212 may utilize a variety of physical storage mediums to provide the described functionality including, but not limited to, magnetic storage media and optical storage media. In one embodiment, at least a portion of reporting and data storage functionality may be provided by external servers and/or data storage backend platforms. For example, reporting module 206 may communicate and interoperate with an external, cloud-based reporting and database system, such as that provided by SalesForce.com. Likewise, in other embodiments, the various functions described with herein with respect to server application module 202 may be distributed over one or more cloud-based application and/or database server platforms.

According to one aspect, communication module 214 is adapted to facilitate communication with one or more survey client modules, as previously described herein. As such, communication module 214 is adapted to interoperate with and generally facilitate communications with survey client module 104 via survey client communication module 118. A variety of communication protocol stacks and languages may be implemented by communication module 214 within the scope of the subject matter described herein, including but not limited to, transmission control protocol/Internet protocol (TCP/IP), user datagram protocol/Internet protocol (UDP/IP), Hypertext Transfer Protocol (HTTP), Extensible Markup Language (XML), Hypertext Markup Language (HTML), Simple Object Access Protocol (SOAP), Session Initiation Protocol (SIP), etc.

According to another aspect, communication module 214 is adapted to facilitate communication with a surveying user entity via a communication interface other than survey client-based communication module 118. For example, communication module 214 is adapted to facilitate communications with a web browser (e.g., Chrome, Internet Explorer, FireFox, etc.). Such web browser interface support may be used, for example, by a surveying or user entity to provision survey system information.

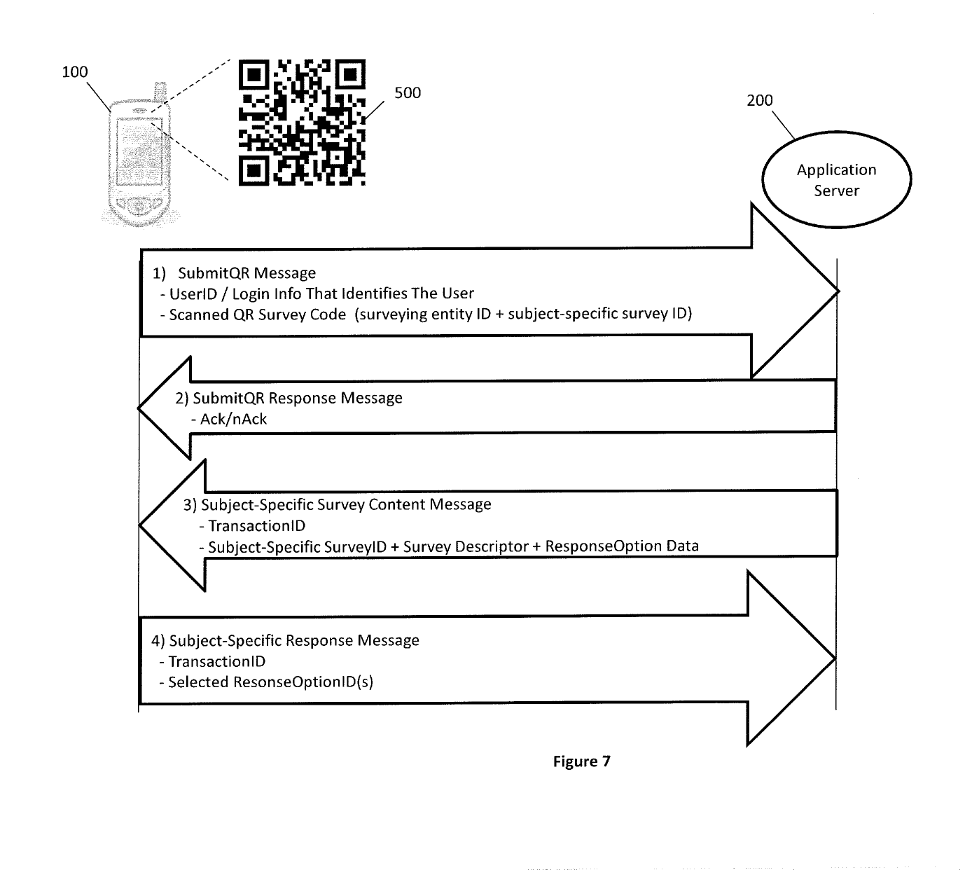

FIGS. 7 through 9 present various exemplary communication/signaling scenarios that may be associated with embodiments of the subject matter described herein. These communication scenarios are not intended to represent all possible information communication scenarios, and are instead merely illustrative in nature.

FIG. 7 includes mobile communication device 100 (e.g., smartphone), which includes a camera module and a survey client module previously described herein. Also included is application server 200, which includes a server application module previously described herein. In the exemplary scenario illustrated, smartphone 100 runs, executes, or activates the survey client module residing on the device. A user of smartphone 100 navigates within the survey client module menu structure so as to reach a point where the user is prompted to use the associated camera module to scan a subject-specific survey QR code icon 500 that is associated with a surveying entity. In this example, subject-specific survey QR code icon encodes information that identifies a surveying entity (i.e., Luigi's Pizzeria: SurveyingEntityID=001) and a subject-specific survey area (i.e., “Wait Staff Service”: Code 111). The scanned QR code icon is decoded, yielding the code “001111”. The code “001111”, along with current geo-location coordinate information (i.e., Long, Lat, Elev) and information that identifies the user is communicated to application server 200 via SubmitQR message 1. It will be appreciated that in other embodiments, user identifying information may be provided to the application server 200 in a separate message during a manual or automatic user login transaction. Application server 200 acknowledges receipt of the SubmitQR message with a SubmitQR Response message 2. Application server 200 logs and processes the scanned subject-specific survey and surveying entity information provided by the user, and provides subject-specific survey content information in Subject-Specific Survey Content message 3. In this example, Subject-Specific Survey Content message 3 includes a transaction identifier, a subject-specific survey identifier, survey response descriptor information, and response option content. In this example, the transaction identifier is “d254c546873”, the subject-specific survey identifier is “001300”, the survey response descriptors are “Service Was Poor”, “Service Was Great!”, and the response option IDs are “01” and “02”, respectively.

The survey response descriptor and response option content is displayed to the user, who is permitted to select some or all of the response options. For example, the user may use touchscreen capability on the smartphone to select some or all of the displayed response options. Once selection is complete the user, via the survey client module user interface, causes the selected response option information to be communicated to application server 200 via Subject-Specific Response message 4. The Subject-Specific Response message includes transaction identifier information and selected response option information, and current geo-location coordinate information (i.e., Long, Lat, Elev). In this example, the transaction identifier is “d254c546873”, the selected response option content includes the following: ReponseOptionID=02—“Service Was Great!”, and current geo-location information includes current Long., Lat., Elev. coordinates. Application server 200 logs the subject-specific survey selected response option information provided by the user. It will be appreciated that application server 200 could provide additional follow-up survey content information via one or more additional Follow-up Survey messages, thereby progressively soliciting more and more specific or targeted feedback from the user following the initial subject-specific QR code scan by the user. The ability to progressively focus the survey content presented to a user following the scanning of a more general but subject-specific QR code-based feedback icon is one of several advantages of the subject matter described herein.

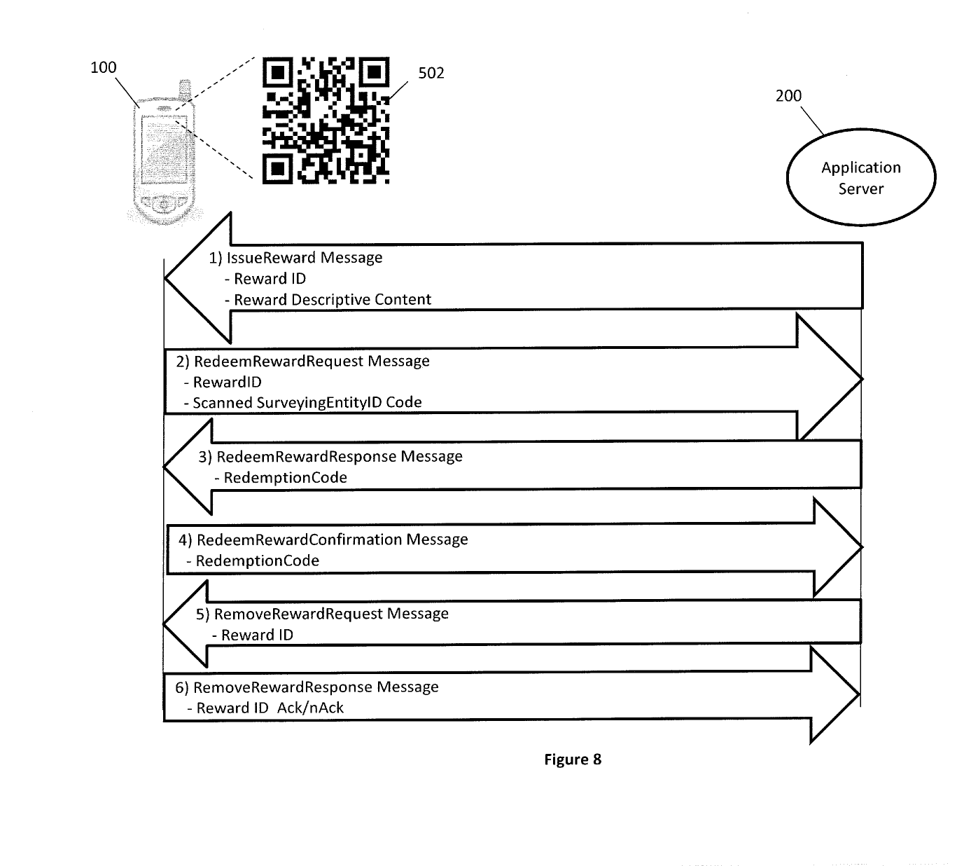

FIG. 8 includes mobile communication device 100 (e.g., smartphone), which includes a camera module and a survey client module previously described herein. Also included is application server 200, which includes a server application module previously described herein. In the exemplary scenario illustrated, smartphone 100 runs, executes, or activates the survey client module residing on the device. In this operational scenario, application server 200 determines that the user of smartphone 100 has earned or should be distributed a reward, such as a survey participation reward. This could be, for example, the result of the user providing the survey response feedback information described previously with respect to FIG. 7. In one embodiment, the participation reward is selected based, at least in part, on survey subject identification information received by application server 200. In any event, application server 200 communicates an IssueReward message 1 to smartphone 100. IssueReward message 1 includes a survey participation reward identifier and descriptive content associated with the reward. In this example, the survey participation reward identifier is “34532433” and the reward descriptive content is “$2 Off Any Item.” The survey client module associated with smartphone 100 receives and stores/caches the survey participation reward information and displays it on-demand to the user. In various embodiments, survey participation reward content may be either “pushed” by application server 200 (such as is described above), or “pulled” by the survey client module on smartphone 100 (i.e., the survey client module may request that reward content be sent by application server 200).

Continuing with the exemplary operational scenario presented in FIG. 8, the smartphone user navigates within the user interface menu structure provided by the associated survey client module on the smartphone so as to reach a point where the user is prompted to select the survey participation reward that is to be redeemed. Once the user has selected the reward that is to be redeemed, the user is prompted to use the associated camera module to scan a redemption QR code icon 502. In this example, redemption QR code icon encodes information that identifies the surveying entity with which the reward is being redeemed (i.e., Luigi's Pizzeria: SurveyingEntityID=001). The surveying entity with which the reward is being redeemed is also referred to herein as the redemption entity. In other embodiments, the redemption QR code could be, for example, a randomly generated code or an arbitrary code selected and provisioned by or for the redemption entity. The scanned redemption QR code icon is decoded, yielding the code “001”. The code “001”, along with the selected survey participation reward identification information RewardID=34532433 are communicated to application server 200 via RedeemRewardRequest message 2. Application server 200 acknowledges receipt of the RedeemRewardRequest message with a RedeemRewardResponse message 3. The ReedemRewardResponse message includes a redemption authorization code, “22354546”, which is displayed to the user. In practice, the redemption entity asks to view the redemption authorization code so as to verify that the reward is valid and has been processed by/is considered redeemed by application server 200. The messaging scenario shown in FIG. 8 assumes that the user takes an action that signals application server 200 with a ReedemRewardConfirmation message, which confirms that the redemption authorization code has been received and used, and at this point the application server 200 considers the reward to have been successfully redeemed/used. However, embodiments of the subject matter described herein may be implemented that do not require such ReedemRewardConfirmation message signaling from the user in order to complete the redemption transaction. In this embodiment, application server 200 considers the redemption transaction complete when the redemption authorization code (i.e., message 3) is successfully received by the survey client module on the smartphone. Once the redemption transaction is complete, application server 200 signals the survey client module on smartphone 100 with a RemoveRewardRequest message 5, which causes the survey participation reward content associated with the redeemed reward (i.e., RewardID=34532433) to be either marked as “redeemed” or deleted from the smartphone. For example, the reward content associated with RewardID=34532433 is deleted from the survey client data storage module and RemoveRewardResponse message 6 acknowledging the deletion is generated and sent from smartphone 100 to application server 200.

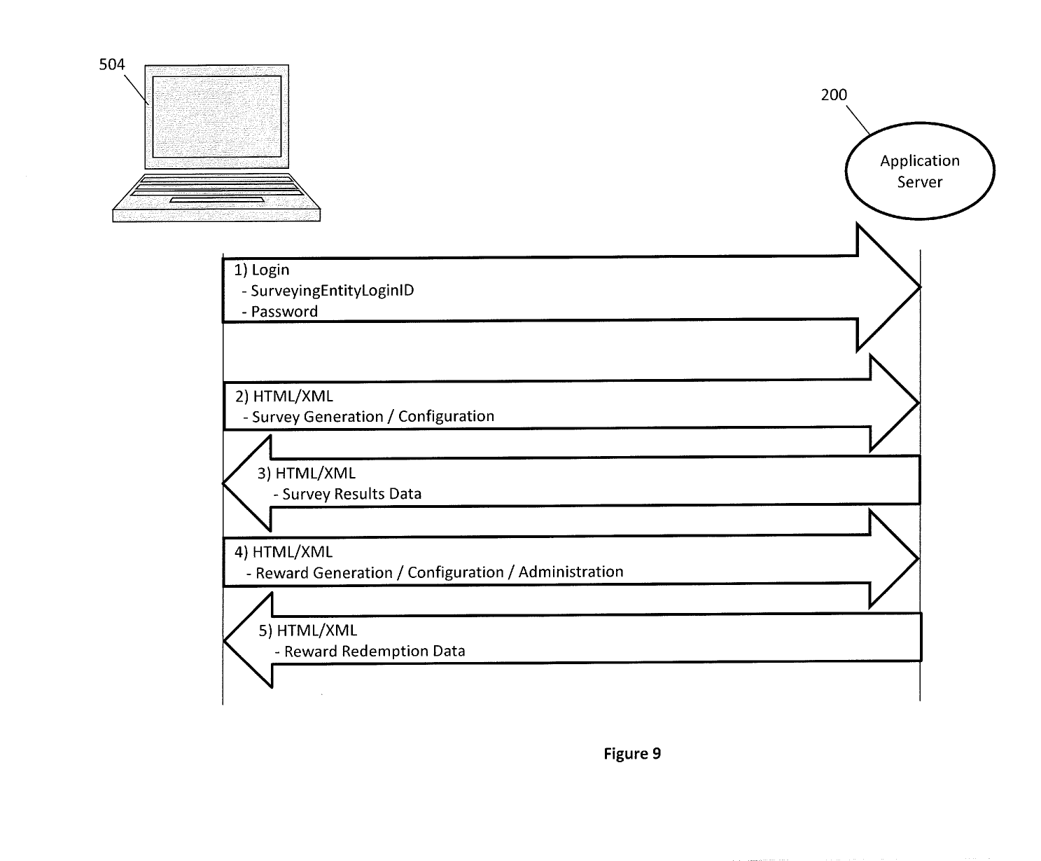

FIG. 9 illustrates an exemplary provisioning and report access scenario. FIG. 9 includes a communication terminal 504, such as a personal computer, tablet computer, netbook computer, laptop computer, mobile computing device, or smartphone that is capable of communicating with application server 200. In one embodiment, communication with application server 200 may be accomplished via a web browser client (e.g., Chrome, Internet Explorer, FireFox) running or executing on communication terminal 504. Communication terminal 504 may utilize a data network (e.g., public Internet, wide area network, mobile data network) to facilitate communication with application server 200. In this example, a surveying entity (or other system provisioner) invokes a web browser on communication terminal 504 and directs the web browser to a uniform resource locator (URL) associated with a server application module hosted on application server 200. The surveying entity submits login credentials, including a username and password via a system Login message 1. Surveying entity is then able to access, provision and configure survey content via message 2. Surveying entity may request and receive reports associated with survey content and survey response data via message 3, which may be generated and sent from application server 200. Surveying entity is able to use this provisioning interface to configure and administer survey participation reward content via message 4. Surveying entity may request and receive reports associated with survey participation reward distribution and redemption data via message 5, which may be generated and sent from application server 200.

### Coupon Distribution Algorithms

With further regard to the distribution of rewards, it will be appreciated that Reward Control Logic Module 210 may employ various algorithms for specifying the number, type and frequency of reward distribution to users. For example, in one embodiment, a new user may be given a reward after submitting a single survey response, whereas a long-time user may be given a reward only after providing multiple survey responses. In another embodiment, a long-time user who has become inactive and not provided survey responses for a prescribed period of time (e.g., has not provided any survey feedback for 2 months) may be given a reward after submitting a single survey response as a means for encouraging use/participation. In other scenarios, reward distribution frequency to a user may be increased (or decreased) as the user increases their frequency of participation.

### Detection of Disingenuous Survey Response Feedback

In one embodiment, survey control logic module 208 includes logic that is adapted to monitor responses received from a user and to analyze these responses over time to determine whether the user is attempting to flood the system with minimally useful or disingenuous survey response information. For example, a user may scan multiple subject-specific survey QR codes for the same merchant and submit associated subject-specific feedback within a short time interval in the hopes of receiving a large number of rewards. Such disingenuous survey responses are counterproductive both from a reward issuance perspective and a qualitative/aggregate survey response statistics perspective (i.e., such frivolous responses do not provide the merchant with meaningful feedback, and make the interpretation of valid responses more difficult.). Survey control logic module 208 may employ one or more survey response profiling algorithms to determine whether a user has provided disingenuous survey response information. One exemplary survey response profiling algorithm detects whether one or more duplicate survey response values are provided by a user within a pre-determined time period. Another exemplary survey response profiling algorithm detects whether contradictory survey response values are provided by a user within a pre-determined time period. For example, a user who provides a first survey response value of “Service Was Great!” followed shortly by a second survey response value of “Service Was Poor” may be flagged as providing disingenuous survey response information. Another exemplary survey response profiling algorithm detects whether the number of survey responses provided by a user with respect to a given merchant during a prescribed time period exceeds a pre-determined threshold value.

In one embodiment, such profiling algorithms are operable to access received survey response information and associated survey response metadata. Exemplary survey response metadata may include, but is not limited to, receipt date- and time-stamp information, information that is indicative of the point-of-scan location (e.g., zipcode, city, state, GPS coordinates, etc.), survey response “demeanor” (e.g., “positive”, “neutral”, “negative”). With regard to survey response demeanor, it will be appreciated that such classification information may be provisioned for each possible survey response during the construction of survey content via provisioning module 204. As such, each possible scanable survey response may be generally classified according to a particular demeanor values (e.g., “positive”, “neutral”, “negative”). In various embodiments of the subject matter described herein, survey control logic module 208 is adapted to access and analyze received survey response information and associated survey response metadata related to a particular user. Using such survey response information and associated survey response metadata, any number of profiling algorithms may be implemented within the scope of the subject matter described herein. As discussed previously, one profiling algorithm involves analyzing survey responses and associated metadata to determine if the number of survey responses received during a prescribed time period (e.g., 5 minutes) exceeds a threshold value. Another exemplary profiling algorithm involves analyzing survey responses and associated metadata to determine if the number of survey responses received during a prescribed time period (e.g., 5 minutes) exceeds a threshold value and whether at least a portion of the received survey responses have conflicting demeanor values.

In response to determining that a user has provided disingenuous survey response information/feedback, survey control logic module 208 is adapted to take a mitigation action. Exemplary mitigation actions may include, but are not limited to, discarding those survey responses that were deemed to be disingenuous, marking or flagging those survey responses that were deemed to be disingenuous and storing them in data storage module 212, communicating with reporting module 206 and/or reward control logic module 210 (e.g., via the marking or flagging described previously) so that the disingenuous survey responses are not reported or rewarded. A warning message may also be sent to the offending user and/or the user's account may be suspended or terminated.

### Use of QR Code & Cookie to Open Reward Wallet

A special purpose “reward redemption” scanable code (e.g., QR code) may be generated by provisioning module 204. The reward redemption QR code may include information which is received and interpreted by one or more modules associated with the scanable survey system as a request to display survey participation reward information so that it may be viewed and/or redeemed. For example, the reward redemption QR code icon may include or incorporate a reward redemption command code value (e.g., alphanumeric code) which is resolved and interpreted by the scanable survey system as an instruction to display available survey participation reward information to the user who scans the reward redemption QR code. When scanned by scanable code reader module 106, the reward redemption command code value incorporated within the reward redemption QR code is extracted and triggers the display of available survey participation reward information to the scanning user. In one embodiment, the filtering and displaying of rewards in the user's reward wallet may be facilitated, at least in part, by reward control logic module 114 and data storage module 116. In another embodiment, the filtering and displaying of rewards in the user's reward wallet may be facilitated, at least in part, by reward control logic module 210 and data storage module 212.

The reward redemption QR code may also include information which identifies a surveying entity (e.g., business or merchant). The act of scanning the special purpose reward redemption QR code causes the Survey Client Module 104 on the user's mobile device to display the user's rewards/reward wallet. If the scanned reward redemption QR code includes information which identifies a surveying entity, the specific reward(s) displayed to the user may be those associated with the specified business or merchant. According to one embodiment, when the reward redemption QR code is scanned by Survey Client Module 104, a previously generated cookie (or other login credential data structure/file) that includes user login credentials is accessed. The login credentials may be used to automatically log the user in to an interface (e.g., AAA interface function within communication module 214) associated with Server Application Module 202, so that rewards may be displayed and/or redeemed by the user. In another embodiment, the login credentials may be used to automatically log the user in to an interface associated with Survey Client Module 104, so that rewards may be displayed and/or redeemed by the user.

In cases where the scanned reward redemption QR code includes information which identifies a surveying entity, the surveying entity identifying information (e.g., a surveying entityID) obtained from the reward redemption QR code scan may be used to select and display those rewards within the user's reward “wallet”. In one embodiment, the filtering and displaying of rewards in the user's reward wallet may be accomplished, at least in part, by reward control logic module 114 and data storage module 116. In another embodiment, the filtering and displaying of rewards in the user's reward wallet may be accomplished, at least in part, by reward control logic module 210 and data storage module 212.

### Scan Triggered Immediate Notification

In one embodiment, survey content provisioning module 204 illustrated in FIG. 2 is adapted to permit the association of an immediate notification trigger (INT) with a particular subject-specific survey response value, such that when the survey response value is received from a user the associated immediate notification trigger is fired. Associated with each INT is a notification message, a notification mode, and a notification contact address. An exemplary notification message may include a text descriptor associated with the triggering survey response value (e.g., “Restrooms are not clean”) or a voice recording of an alert message. Exemplary notification modes may include, but are not limited to, text message, instant message, short message service, tweet, email, and voice call. Exemplary notification contact address information may include, but is not limited to, a mobile subscriber ISDN (MSISDN), a mobile telephone number, an email address, an online user identifier, a uniform resource identifier (URI), a session initiation protocol (SIP) URI, a telephone number, an Internet protocol address, and a Twitter address. In one embodiment, survey control logic module 208 includes logic that is adapted to monitor responses received from a user and to determine if a received survey response value fires an INT. In response to determining that an INT should be fired, module 208 generates the INT-specified notification message and transmits or causes the notification message to be transmitted to the specified notification contact address. It will be appreciated that more than one notification contact address may be associated with an INT, and consequently multiple notification messages may be generated in response to the firing of a single trigger.

### Survey Response Analytics

According to one aspect of the subject matter described herein, survey control logic module 208 includes logic that is adapted to monitor and record survey responses received from a user, where each survey response is associated with a surveying entity (e.g., merchant or business). Each surveying entity is classified according to a pre-defined classification framework. For example, surveying entity X may be classified as “Restaurant:Table Service:Italian”, surveying entity Y may be classified as “Physician:Family Practitioner”, etc. Geo-location information (e.g., zip code, city, state, GPS coordinates) for each surveying entity is maintained/accessible by survey control logic module 208. Using this information, module 208 is adapted generate a usage profile for the user which reflects survey entity usage/patronage patterns. For example, over time, module 208 may monitor and record/store (via data storage module 212) 100 survey responses that are provided by the user, where each response (and associated metadata) is associated with a survey entity. Module 208 includes logic that is adapted to analyze the 100 survey responses and determine that the user has repeatedly visited/patronized surveying entity X and surveying entity Y in the past 3 months. Based on this usage profile, module 208 is adapted to identify another surveying entity that has both a similar classification to that of surveying entity X as well as a similar geo-location. This surveying entity that has both a similar classification to that of surveying entity X as well as a similar geo-location is referred to herein as an “introducible” surveying entity. As the term suggests, an introducible surveying entity is one that the analytics algorithm or profiling logic associated with module 208 determines may be of interest to the user based on the user's observed usage/patronage patterns. Module 208 may send/trigger/suggest the sending of a message to the user suggesting that the user may want to patronize the similar surveying entity. Exemplary message content may include, but is not limited to, an advertisement, reward, or coupon. Messages may be communicated to the user and viewed, for example, via Survey Client Module 104 or alternatively via email, text messaging service, instant messaging service, Twitter, direct mailing, or other communication means.

### Reward Sharing

In one embodiment, module 210 may facilitate the sharing, gifting, or transfer of a survey participation reward from one user to another user. In this case, a first user who is the current owner of a survey participation reward, selects the reward and identifies a second user to whom the reward is to be transferred. The first user then communicates information that identifies both the reward and the “transferred to” user to module 210. The information that identifies the “transferred to” or recipient user may be a username or user ID provided by the recipient user at the time of registration by the recipient user. Module 210 receives, processes and logs the transfer request and updates the appropriate reward data so as to execute the transfer. In one embodiment, reporting module 206 enables a surveying entity or user to view, track and analyze such reward transfers. In various embodiments of the subject matter described herein, restrictions/limitations/qualifications may be imposed on rewards that are to be transferred or gifted from one user to another. For instance, module 210 may include reward transfer or gifting rules that specify those conditions under which a reward may be transferred and/or those conditions under which a reward may not be transferred. These rules may be stored in a database, table, or data structure that is contained within or accessible by module 210. An exemplary rule may state that a reward may only be transferred or gifted to a new user (e.g., a user that has registered for service within the past 30 days, etc.). In order to enforce this rule module 210 may access user registration data that is maintained in data storage module 212. Another exemplary rule may state that a reward may only be transferred or gifted to a user who has not previously patronized the surveying entity with which the reward is associated. In order to enforce this rule module 210 may access user survey response data that is maintained in data storage module 212.

In one embodiment, an existing user may transfer or gift a reward to an individual who has not yet become a registered user. To facilitate such a special transfer, the existing user communicates information that identifies both the reward and the “transferred to” or recipient user to module 210. In this case, since the recipient user is not yet a registered user of the system/service, the existing user must specify a public contact address for the intended recipient. Exemplary public contact addresses may include, but are not limited to, an email address, a mobile telephone number, a mobile subscriber ISDN (MSISDN), a Twitter address, an instant message address. Module 210 receives processes and logs the transfer request. In one embodiment, module 210 is adapted to generate a message that is addressed to the specified public contact address (e.g., email address). In one embodiment, the message may include the transferred reward or information specifying how the transferred reward may be obtained and redeemed. In another embodiment, the message may include information that describes the pending reward transfer and also provides a hyperlink/URL associated with a web page where the intended recipient may register and thereby receive and redeem the transferred reward. The existing user that transferred or gifted the reward (thereby resulting in the recruitment/registration of a new subscriber) may be issued a new reward as a result of the transfer. The new reward may be the same as the transferred reward or different. The new reward may be issued by reward control logic module 210.

### Auxiliary Survey Identifiers

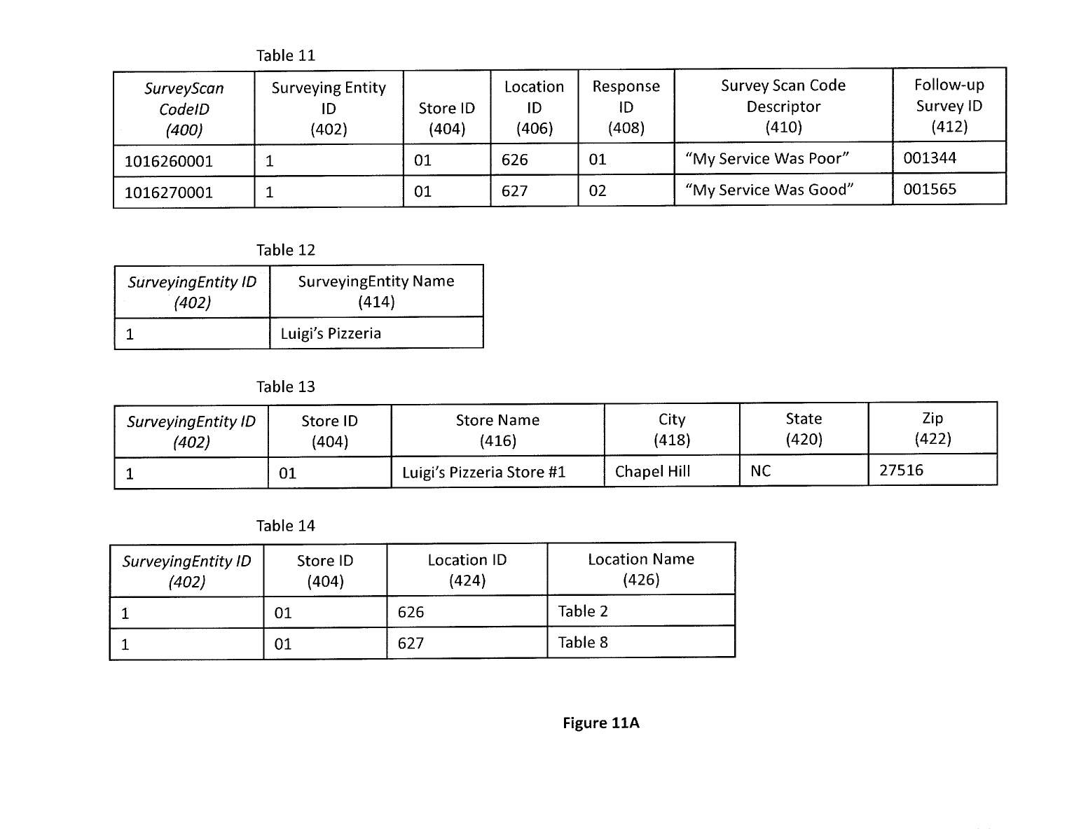

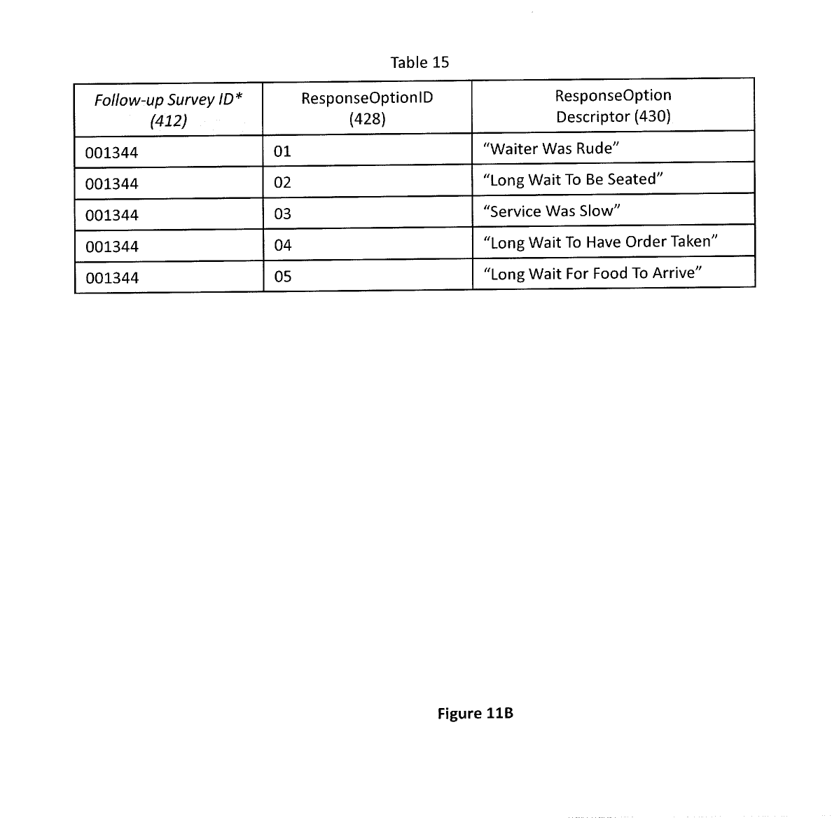

In one embodiment of the scan-based services platform, a surveying entity, such as a restaurant owner, may log-in to server application module 202 and, via module 204, construct or provision survey content associated with a survey of customer satisfaction with the service at the owner's restaurant. The surveying entity may implicitly or explicitly define a primary survey question, such as “How was the service?” In the case of an explicitly defined primary survey question, the literal question may be stored in a data structure or database associated with data storage module 212. One or more responses associated with the primary survey question are also defined and stored in data storage module 212. Exemplary responses might include, “My Service Was Poor” and “My Service Was Good”. In one exemplary embodiment, a code is associated with each defined response to the primary survey question. As such, the code is explicitly associated with the response and implicitly associated with the primary survey question. Exemplary survey content data is presented in Table 11, shown in FIG. 11A. Each exemplary survey content record in Table 11 includes a QR code identifier 400, a SurveyingEntityID 402, a store/site ID 404, a location type indicator 406, a response ID 408, QR code descriptor text descriptor information 410, and follow-up survey identification information 412. It will be appreciated, in the sample data shown in Table 11, that the QR code identifier values chosen incorporate the SurveyingEntityID value in the first digit. As such, the QR code assigned to the survey response option “My Service Was Poor” includes information that is sufficient to explicitly identify both the surveying entity (i.e., “Luigi's Pizzeria”) with which the survey is associated and the survey response option (i.e., “My Service Was Poor”). It will also be appreciated that, in this particular example, the survey question itself (i.e., “How was the service?”) is implicit and may be inferred from the possible survey response options that are available. Hence, in one sense, the QR code can also be thought of as including a triplet of survey-related information sufficient to identify a surveying entity, a survey response, and, implicitly, an associated survey question. Also provisioned in Table 11 and incorporated in the associated QR scan-code 400 is what is referred to herein as auxiliary survey information. In this example, the auxiliary survey information includes location information, such as a retail location or store/site location (e.g., Luigi's Pizzeria store #1). In one type of implementation, such location information may be thought of as information which can be used to identify the deployment location associated with a survey scan-code. This location information should not be confused with user- or mobile device-provided geo-location information, such as Global Positioning System (GPS) coordinates provided by a GPS module in a user's smartphone. The location information described here is location information that is statically encoded within a survey scan-code, such as a QR code. Location information may also include intra-store or intra-site location information (e.g., Table #2, Table #8, inside seating area, outside seating area, bar area, upstairs, downstairs, etc.). It will be appreciated that such auxiliary survey information may be incorporated in a scan code as a concatenated string of digits or characters, or may alternatively represented in the scan code as a hash value consisting of numbers or characters that can be interpreted by the server in manner such that the associated auxiliary survey information can be resolved/identified. Tables 12 through 15 in FIGS. 11A and 11B illustrate exemplary data and data structures that may be used by server application module 202 to facilitate the provisioning and subsequent processing of survey content information and auxiliary survey information in one exemplary embodiment of the subject matter described herein.

Provisioning, administration and billing module 204 is adapted to generate an encoded scanable graphic icon (e.g., QR code icon) associated with each possible survey response, where the information encoded in the scanable graphic icon includes, at least, the associated response code (e.g., QR code). In an alternate embodiment, information that can be used to identify the associated surveying entity may be separately encoded in the scanable graphic icon. The surveying entity may download and print or otherwise display these scanable graphic icons at various locations within, for example, a restaurant so that they may be scanned by a patron/user of mobile communication device 100.

According to one aspect of the subject matter described herein, in response to the scanning of a scanable survey code (e.g., QR code) that encodes a surveying entity identifier and survey response option identifier and auxiliary survey identifier information, follow-up or “micro” survey content information may be sent to a user. Shown in FIGS. 11A and 11B, Tables 11 and 15, is exemplary follow-up survey content which may be provisioned by a survey entity via module 204, in a manner similar to that previously described in this disclosure. Table 11 includes Follow-up survey ID information 412, while Table 15 includes Follow-up survey ResponseOptionID information 428, ResponseOption Descriptor information 430, and optionally a pointer to another response option-dependent Follow-up survey (not shown).

In a manner similar to that previously described, when a user scans a survey scan code (e.g., QR code) tag that encodes the value “1016260001” which is associated with the survey response option “My Service Was Poor” (see Table 11, record 1), the user's survey client module 104, in one embodiment, extracts the encoded value and communicates this value to server application module 202. In some embodiments, information which can be used to identify the user (e.g., user login credentials) may also be communicated with or associated with the scan-code value that is sent to module 202. Processing elements associated with module 202 are adapted to process and store the received scan-code. If information that can be used to identify the scanning user is also provided, then module 202 may additionally associate and store information that can be used to identify the scanning user with the received scan-code value. For example, module 202 may create a binding record which includes information which can be used to identify the scanning user as well as the survey content and auxiliary survey information associated with the received scan-code information. As generally described previously, module 202 may also facilitate the communication of subsequent follow-up survey content to the survey client module 104 associated with the scanning user. In this example, the follow-up survey content includes the response options “Waiter was rude”, “Long wait to be seated” and others, as generally illustrated in Table 15. In practice, the user may select some or all of the provided response options. The user's response option selection(s) are then communicated to the server application module 202 where they are processed and recorded. Additional follow-up surveys may be sent to the user based on the response option(s) selected.

According to one aspect, survey control logic module 208 is adapted to receive and process scanned survey code (e.g., QR code) information from one or more survey client modules. Module 208 facilitates the storage of collected survey code information, including survey content information and the associated auxiliary survey information, within an associated data storage module. In an alternate embodiment, module 208 is adapted to decode or “read” an image provided by a survey client module. The image may be, for example, a JPEG formatted graphic image of a QR survey scan-code icon. The decoded information extracted from the QR survey scan-code icon is then processed and stored in a manner similar to that described above. Module 208 is adapted to receive and log or record scanned survey code (e.g., QR code) information, including survey content information and the associated auxiliary survey information, from a survey client module associated with a user. Module 208 may also access provisioned follow-up survey rules and communicate follow-up survey content to the user based on the provisioned rules. Module 208 may subsequently receive follow-up survey response information from the user, and log or record this follow-up survey response information and again access the provisioned follow-up survey rules and communicate additional follow-up survey content to the user based on the provisioned rules. As such, when a user scans a suitably provisioned survey scan-code, not only is the user's survey feedback (e.g., “My Service Was Poor”) captured and stored by server application module 202, but any auxiliary survey information (e.g., store location or branch identity, table number, seating area, etc.) associated with the survey scan-code is also received and recorded by server application module 202.

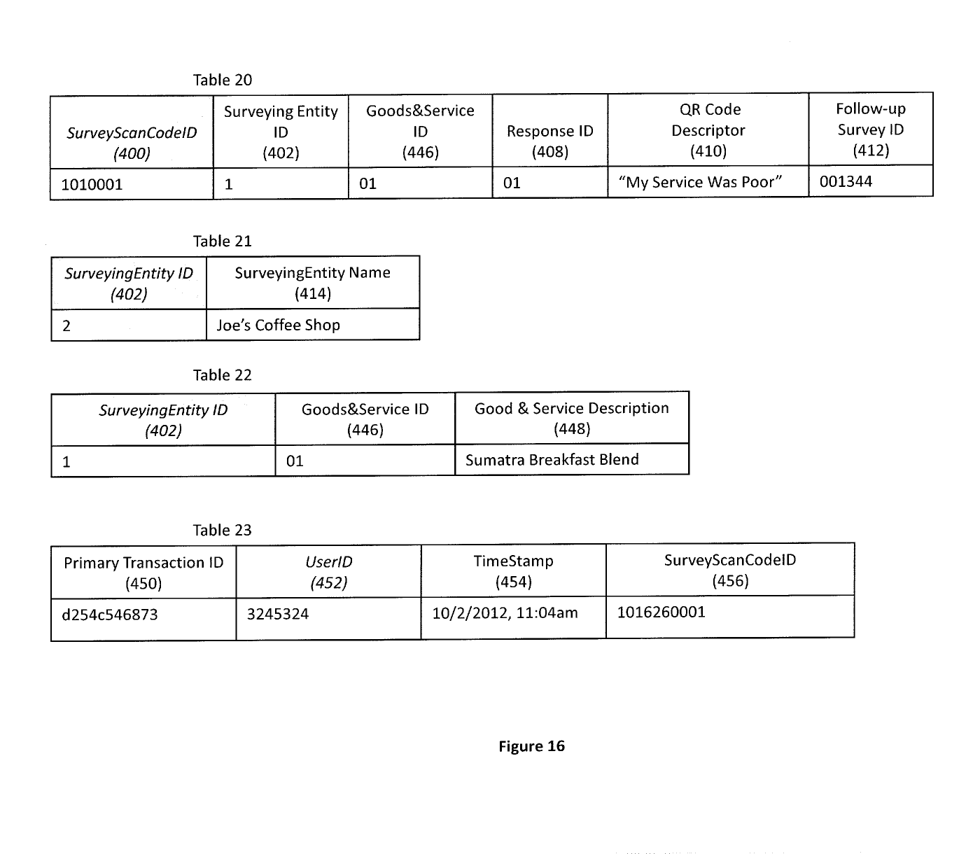

Shown in FIG. 16 is Table 23, which includes exemplary survey response transaction data that is stored, for example, in data storage module 212. Table 23 includes survey response transaction identifier information 450, UserID information 452, transaction timestamp information 454, and scanned survey code information 456. In this example, it will be appreciated that processing logic associated with server application module 202 can easily use the stored survey code information 456 associated with the user's scan transaction in conjunction with the data stored in Tables 11 through 15 to determine or extract the survey response content/details as well as the auxiliary survey information associated with the logged scan.

As discussed previously, various embodiments include scanable codes, such as QR codes, that incorporate encoded survey content information that can be used to identify a particular survey response or element of user feedback, as well as auxiliary survey information, such as scan-code deployment location information. In addition to this survey response/feedback information, various embodiments of the subject matter described herein may also utilize additional “auxiliary” survey information that is encoded within a scanable code. This additional information is referred to herein as auxiliary survey information. Examples of such auxiliary survey information include, but are not limited to, information that identifies or can be used to identify a store location, a location within a store, a place, a person (e.g., an employee), a good or service recipient, and a good or service. Examples of store location information include, but are not limited to, information that identifies or can be used to identify a specific one of many stores that are owned or operated by a surveying entity. Examples of place and intra-store location information includes, but is not limited to, information that identifies or can be used to identify a particular location within a store (e.g., men's restroom, dressing room #2, theme park ride #5, theme park restaurant #7, theme park shop #9, airport gate number, etc.), a particular item within a store or place of business (e.g., dining table #5, airline seat number, movie theater #4, etc.), or a particular item, object or thing (e.g., airline flight number, movie title, etc.). In one exemplary use case of a scanable survey system described herein, information that identifies a political candidate may be encoded in a scanable code such that an embodiment of the subject matter described herein may be used to collect election polling information/statistics. Examples of employee information include, but are not limited to, information that identifies or can be used to identify an individual or employee (e.g., bartender, wait-staff member, theme park attendant, salesperson, customer service representative, etc.). Examples of a good or service recipient information includes, but is not limited to, information that identifies or can be used to identify a person, a customer, business patron, theme park visitor, physician's patient, a sales order, a purchase order, an customer account identifier, etc. Examples of a good or service information includes, but is not limited to, information that identifies or can be used to identify a consumer product (e.g., type of coffee drink, type of pizza, etc.) or a service provided to a consumer (e.g., type of spa service, type of dental visit, etc.).

It will be appreciated that such auxiliary survey information may be incorporated within a scanable code in a form such that the encoded information includes the identifiers for the associated auxiliary survey information. For example, in the case of employee information, the employee information encoded in a QR code may be the employee's name (e.g., “Bob Smith”). Alternatively, the auxiliary survey response information may be incorporated within the scanable code in a form such that the encoded information is sufficient for an associated server application module (previously described) to determine the employee's name by consulting a pre-configured auxiliary survey identifier-to-employee name mapping data structure or binding record that was provisioned prior to the scan. For example, the survey scan-code may include, in addition to survey content (e.g., response option identifier, survey subject area identifier, survey question identifier, etc.) employee identification information in the form of a 5 digit code “34345”. When this information is scanned and provided to the server application module, the server application module is able to extract the “34345” code and use this code to perform a lookup in a data structure that associates the code “34345” with the text name “Bob Smith.” In either embodiment, the server application module is able to receive the auxiliary survey response information and interpret it appropriately. In various embodiments of the subject matter described herein, a single scanable code may include multiple elements of auxiliary survey information. Such information may, for example, be concatenated and encoded within the scanable code, or may be encoded using a hashing or indexing function. It will also be appreciated that in some embodiments of the subject matter described herein, this auxiliary survey information may be used by the server application module to determine, at least in part, which (if any) follow-up survey content should be sent to the mobile user who scanned the associated survey scan-code.

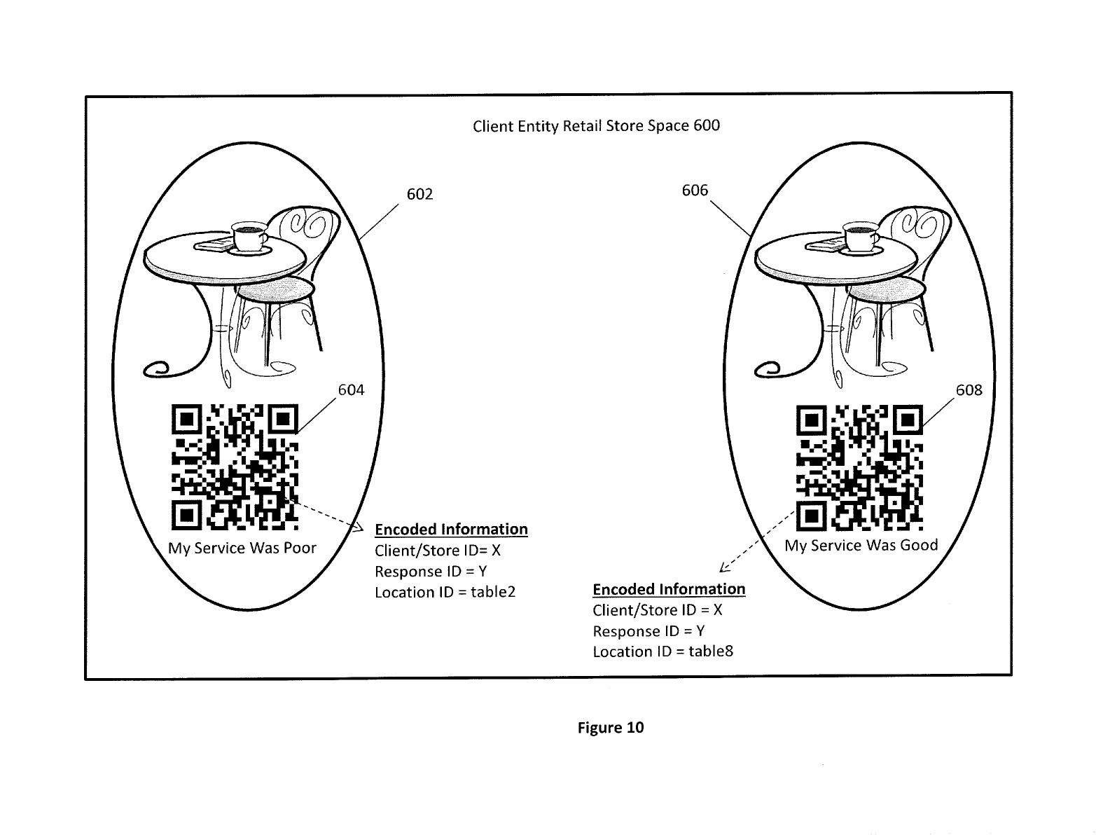

For example, information that identifies or can be used to identify a specific retail store location or site (e.g., Luigi's Pizza, store #1) and information that identifies or can be used to identify a specific location within a store/site premises may be encoded in a scanable survey response code of the subject matter described herein. Shown in FIG. 10 is an example of the use of such location identifying information in a deployment of a scan code driven surveying system. A floor-plan layout of a retail store 600 is illustrated. A location on the left side of the store is labeled 602 in the diagram, while another location on the right side of the store is labeled 604. In the area labeled 602, a scanable QR code 604 is placed that includes encoded information that identifies the client/store (e.g., Luigi's Pizza—store 1), a survey response (e.g., “my service was poor”), and a location or physical object within the store/premises. For example, in the case where the client/store is a restaurant, the location identifier encoded in the scanable code 604 is a dining table number, table2, that is associated with a table in the restaurant. In a similar manner, the scanable QR code 608 includes information that identifies the client/store, a survey response and the dining table identifier, table8, that is associated with a different table in the restaurant. In this way, a scan of either of these survey QR codes by a mobile user enables the survey system to collect, record and analyze information that is at least suggestive of the survey scan-code deployment location/physical location of the user scan. Another exemplary use of such location ID encoding is at an amusement or theme park that includes multiple rides. A deployment of a scanable survey system described herein in such a scenario could include scanable QR code survey icons at the site of each ride. A scanable survey QR code might encode a feedback response corresponding to “the wait in line was too long.” Also encoded in the QR code is a location identifier that could be used to identify the specific ride (e.g., rollercoaster #1) near which the QR code was placed. It will be appreciated that in various embodiments of the subject matter described herein, location identifying information encoded in the scanable survey response code may include, but is not limited to, geo-location coordinate information (e.g., GPS positional coordinates), area proximity identification information (e.g., a code that is used by the application server to, for example, identify “the north building restroom”, “checkout register 1”, etc.), or any other information that can be used to specify or identify a physical location, place, or proximity with which the QR code is to be associated with.

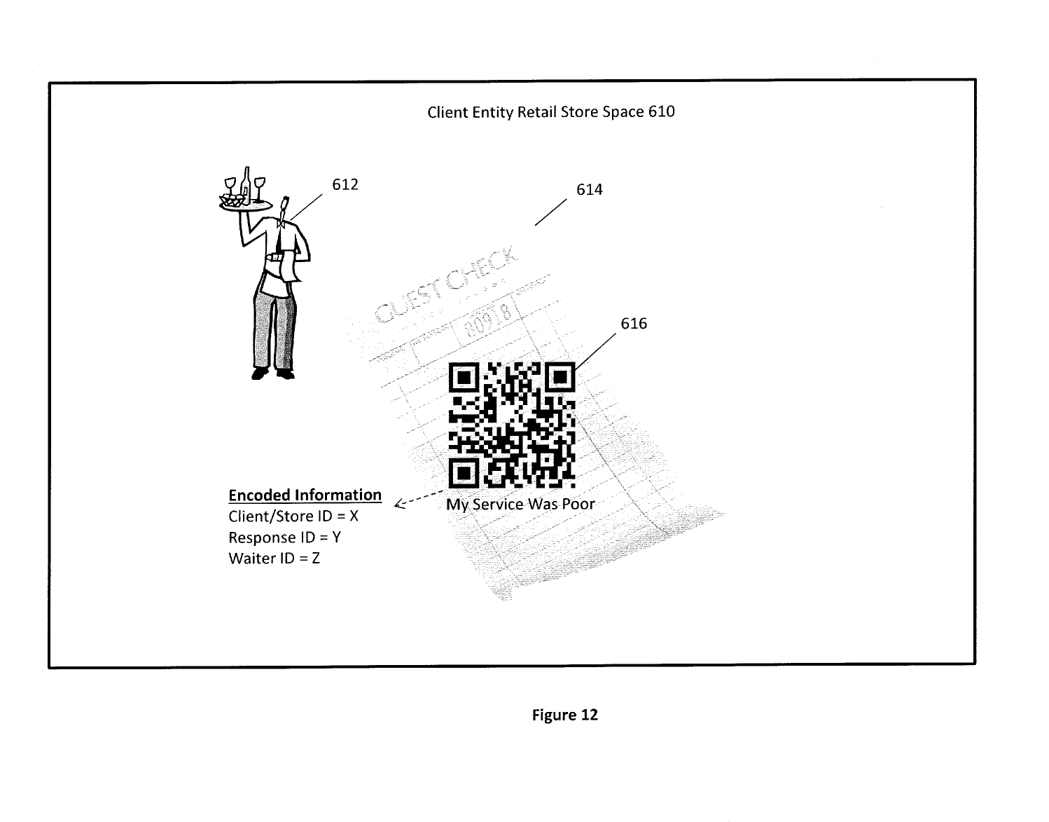

Shown in FIG. 12 is an example of another aspect of the subject matter described herein, where a scanable QR code includes auxiliary survey information that identifies or can be used to identify an employee or service provider representative, such as for example, a waiter or salesperson. In this example, a retail client 610, such as a restaurant, employs a waiter 612 to provide service to a customer. When the customer's check 614 is printed at a point of sale device (POS) by the waiter 612, the POS generates and prints on the check a scanable survey QR code 616 that includes, in addition to a survey response identifier, encoded information that can be used to identify the waiter 612. When the QR code 616 is scanned, the waiter-identifying information along with the survey response identifying information is communicated to an application server associated with the survey system, in a manner similar to that previously described herein.

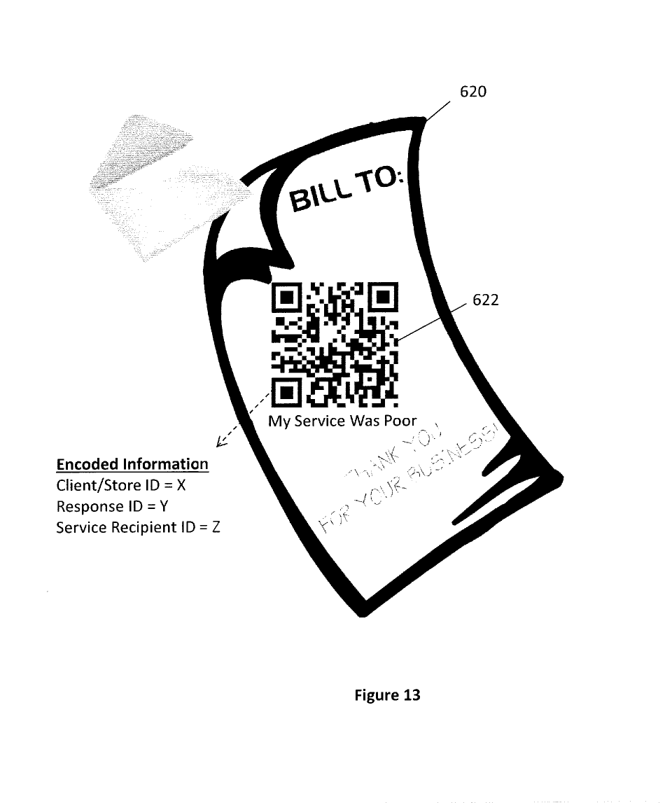

Shown in FIG. 13 is an example of another aspect of the subject matter described herein, where the scanable QR code includes auxiliary survey information that identifies or can be used to identify the recipient of a service or good, such as, for example, a customer who is billed via mail for a good or service. In this example, the customer's bill or invoice 620 is printed so as to incorporate a scanable survey QR code 622 that includes encoded information that can be used to identify the customer (e.g., customer account identifier, service recipient identifier, etc.) as well as a survey response identifier. When the QR code 622 is scanned, the customer-identifying information along with the survey content (e.g., response option identifying information) is communicated to an application server associated with the survey system, in a manner similar to that previously described in this disclosure.

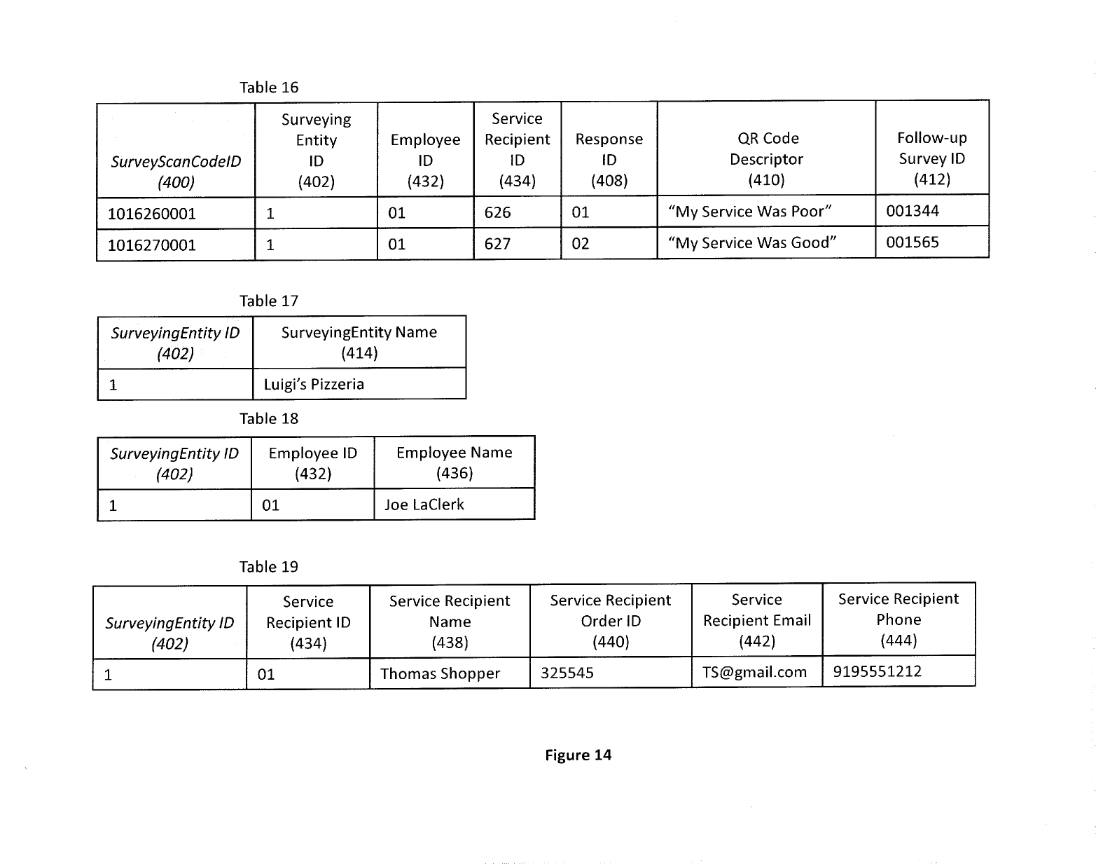

Shown in FIG. 14 are exemplary data structures, Tables 16 through 19, which are intended to generally illustrate exemplary survey content and auxiliary survey data that may be encoded in the scanable QR codes discussed in FIGS. 12 and 13. For these particular examples, Table 16 includes Employee ID information, 432 and Service Recipient ID information 434. Survey content information similar to that previously described in other examples and embodiments is also included, and for the sake of brevity is not described again in detail.

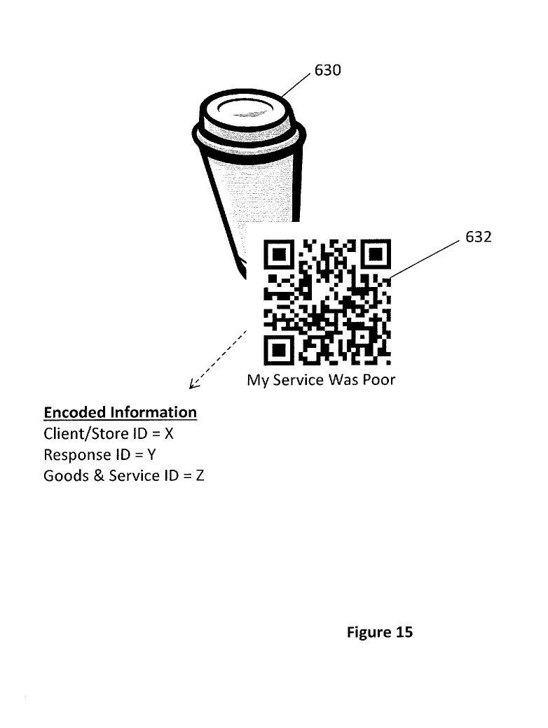

Shown in FIG. 15 is yet another example of a scanable survey response code in accordance with an embodiment of the subject matter described herein, where the scanable QR code includes information that identifies or can be used to identify a service or good, such as, for example, a type of coffee drink. In this example, customer's coffee cup 630 is printed so as to incorporate a scanable survey QR code 632 that includes encoded information that can be used to identify the type or size of coffee drink that the customer purchased (e.g., grande, venti, “chai latte”, etc.) as well as a survey response identifier (e.g., “tasted great”). When the QR code 632 is scanned, the goods-identifying information along with the survey response identifying information is communicated to an application server associated with the survey system, in a manner similar to that previously described herein.

Shown in FIG. 16 are exemplary data structures, Tables 20 through 22, which are intended to generally illustrate exemplary survey content and auxiliary survey data that may be encoded in the scanable QR codes discussed in FIG. 15. For these particular examples, Table 20 includes Good&Service ID information, 446. Survey content information similar to that previously described in other examples and embodiments is also included, and for the sake of brevity is not described again in detail.

It will be appreciated that in various embodiments of the subject matter described herein, some or all of the auxiliary survey information identifiers described herein may be included/encoded in a scanable code in conjunction with survey content data and used with an associated scanable survey system as described herein.

In various embodiments of the subject matter described herein, information that can be used to identify the user who scans a scanable survey code may be communicated to the server application module and recorded, along with the scanned survey response and, in some cases, auxiliary survey response information. In other embodiments, the identity of the user who scans the scanable code may not be known, and the associated scanned survey response and, in some cases, auxiliary survey response information may be reported to the server application module as anonymous feedback. In some embodiments, auxiliary survey information received at server application module 202 as the result of the scanning of a survey scan-code by a user may be used, at least in part, to select a survey participation reward that is provided to the user. Exemplary participation reward data is illustrated in Table 3.

In one embodiment, the server application module may be adapted to receive survey response and auxiliary survey information that is scanned by a user, and in response echo the received information back to the user, if either survey client module 104 or server application module 202 determines that the scanning user is a user who has been granted the necessary administrative privileges to obtain such scan “echo” service. This functionality is particularly useful for administrators of the scanable surveying system as a means of verifying or confirming that a scanable code contains the correct encoded information.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for collecting and distributing survey information using a scan-code based surveying system, the system comprising:
a computing platform including a processor:
a server application module executable by the processor and configured to:
receive surveying entity and survey subject identification information from a survey client module, where the surveying entity and survey subject identification information was obtained by scanning a scanable survey code;
use the received information to select subject-specific survey content; and
communicate the selected survey content to the survey client module.

2. The system of claim 1 wherein the subject-specific survey content includes a selectable survey response option.

3. The system of claim 1 wherein the subject-specific survey content includes a subject-specific question.

4. The system of claim 1 wherein the surveying entity and survey subject identification information is communicated to the server application module in the form of a uniform resource locator (URL).

5. The system of claim 1 wherein the survey client module utilizes a quick response (QR) code scanner to obtain the surveying entity and survey subject identification information.

6. The system of claim 2 wherein the server application module is configured to receive, from the survey client module, in response to a user interaction, information which can be used to identify selection of the survey response option by the user.

7. The system of claim 4 wherein the server application module is configured to communicate follow-up survey content to the survey client module in response to receiving the selected survey response option information.

8. The system of claim 6 wherein the server application module is configured to select a survey participation reward that is returned to the survey client module based, at least in part, on receipt of the information which can be used to identify selection of the survey response option by the user.

9. The system of claim 6 including wherein the server application module is adapted to generate and transmit an immediate notification message in response to receipt of the identified response option selection information.

10. A system for collecting and distributing survey information using a scan-code based surveying system, the system comprising:
a computing platform including a processor;
a server application module executable by the processor and configured to:
receive survey scan code information from a survey client module, where the survey scan-code information includes survey content information and information that can be used to identify an auxiliary survey attribute and where the survey scan-code information was obtained by scanning a scanable survey code;
use at least a portion of the received survey scan code information to identify an auxiliary survey attribute; and
store at least a portion of the survey scan code information, including information sufficient to identify the associated auxiliary survey attribute.

11. The system of claim 10 including wherein the server application module is configured to additionally receive and store information sufficient to identify the user associated with the received survey scan-code information.

12. The system of claim 10 including where the server application module is configured to communicate a participation reward to the survey client module in response to receiving the survey scan-code information.

13. The system of claim 10 wherein the server application module is configured to communicate follow-up survey content to the survey client module in response to receiving the survey scan-code information.

14. A method for collecting and distributing survey information using a scan-code based surveying system, the method comprising:
receiving survey scan code information from a survey client module, wherein the survey scan-code information includes survey content information and information that can be used to identify an auxiliary survey attribute and where the survey scan code information was obtained by scanning a scanable survey code;
using at least a portion of the received survey scan-code information to identify an auxiliary survey attribute; and
storing at least a portion of the survey scan-code information, including information sufficient to identify the associated auxiliary survey attribute.

15. The method of claim 14 including receiving and storing information sufficient to identify the user associated with the received survey scan code information.

16. The method of claim 14 including communicating a participation reward to the survey client module in response to receiving the survey scan code information.

17. The method of claim 14 including communicating follow-up survey content to the survey client module in response to receiving the survey scan code information.

18. A non-transitory computer readable medium having stored thereon executable instructions that when executed by the processor of a computer control the computer to perform steps comprising:
receiving survey scan code information from a survey client module, wherein the survey scan-code information includes survey content information and information that can be used to identify an auxiliary survey attribute and where the survey scan code information was obtained by scanning a scanable survey code;
using at least a portion of the received survey scan-code information to identify an auxiliary survey attribute; and
storing at least a portion of the survey scan-code information, including information sufficient to identify the associated auxiliary survey attribute.

19. The non-transitory computer readable medium of claim 18 including communicating a participation reward to the survey client module in response to receiving the survey scan code information.

20. The non-transitory computer readable medium of claim 18 including communicating follow-up survey content to the survey client module in response to receiving the survey scan code information.
